(19) United States
(12) Patent Application Publication
(10) Pub. No.: US 2023/0385809 A1
(43) Pub. Date: Nov. 30, 2023

(54) SYSTEMS, METHODS, AND APPARATUS FOR COMPOSTING AND WASTE REDUCTION TOKEN CREATION, VALIDATION AND STORAGE

(71) Applicant: Open Mind Developments Corporation, Kelowna (CA)

(72) Inventors: Conor Forkan, Toronto (CA); Jeremy Anthony Lang, Saskatoon (CA); Daanvir Karan Dhir, Kelowna (CA); Aelicia Schmitt, Nanoose (CA); Neutron Her, Kelowna (CA); Brad Hicks, Kelowna (CA); Nico Martin, Kelowna (CA)

(73) Assignee: Open Mind Developments Corporation, Kelowna (CA)

(21) Appl. No.: 18/188,495

(22) Filed: Mar. 23, 2023

Related U.S. Application Data
(63) Continuation-in-part of application No. 17/591,903, filed on Feb. 3, 2022.
(60) Provisional application No. 63/326,003, filed on Mar. 31, 2022.
(60) Provisional application No. 63/352,370, filed on Jun. 15, 2022.
(60) Provisional application No. 63/352,376, filed on Jun. 15, 2022.
(60) Provisional application No. 63/145,515, filed on Feb. 4, 2021.
(60) Provisional application No. 63/254,604, filed on Oct. 12, 2021.

(51) Int. Cl. G06Q 20/36; G06Q 20/38

(52) U.S. Cl. CPC G06Q 20/3672; G06Q 20/389; G06Q 20/3674

(57) ABSTRACT

A household composting device having housing and composting regions for receiving compostable waste material, the device further having a bucket positioned within the housing, a grinding assembly, and a condenser assembly, configured to: facilitate an outlet air flow leaving the composting region via an air outlet; expose the outlet air outlet to a cooler air flow to cause the air flow to condense into a condensate and an inlet airflow; capture the condensate; and redirect the inlet airflow into the composting region. In addition, there is a system and method for the creation of a waste reduction token, based on waste reduction by the device, the method including receiving, from the waste reduction device, a waste reduction data; validating, by a validator, the waste reduction data; and calculating a number of waste reduction tokens, based on the validated waste reduction data.

### CROSS REFERENCE TO RELATED APPLICATIONS

The present application claims priority to U.S. Provisional Application 63/326,003 filed Mar. 31, 2022, U.S. Provisional Application 63/352,370 filed Jun. 15, 2022, and U.S. Provisional Application 63/352,376 filed Jun. 15, 2022, all of which are incorporated herein by reference. The present application is also a Continuation In Part of U.S. application Ser. No. 17/591,903 filed Feb. 3, 2002, which claims priority to U.S. Provisional Application 63/145,515 filed Feb. 4, 2021 and U.S. Provisional Application 63/254,604 filed Oct. 12, 2021, all of which are incorporated herein by reference.

### BACKGROUND

Various entities, persons, organizations and companies, are increasingly seeking various ways to reduce their waste and energy use. While waste is being reduced, the actual reduction is not being captured, quantified, validated and made transparent.

This problem applies to both legacy waste reductions, and to future waste reductions.

Composting devices are known to implement a composting cycle for biologically and chemically decomposing refuse, such as organic food waste, into compost for use as a fertilizer and soil amendment. The composting cycle may be implemented in a composting bin by providing water, heat and aeration to the refuse, and may require a period of time for completion.

However, most composting devices have one or more limitations in their use and usefulness, such as i) they do not handle non-food waste compostable materials, ii) they do not provide information about the waste put in the device, and the outputs from the device, iii) they do not indicate how much “waste” the composter has saved, and iii) the composter's functionality is not practical for a user and for the location of the composter in the user's space.

Therefore, there is a need for a system and device for composting that addresses one or more of the above limitations along with a system and device to create tokens to create, validate and store data related to legacy and future proof of waste reduction data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates to systems and methods for quantifying and storing proof of waste, and related environmental benefits and more particularly to receiving, from specialized waste reduction devices, validated waste reduction data that is then stored.

### SUMMARY OF THE INVENTION

There is a method for the creation of a waste reduction token, based on waste reduction by a waste reduction device, the method comprising (a) receiving, from the waste reduction device, a waste reduction data; (b) validating, by a validator, the waste reduction data; and (c) calculating a number of waste reduction tokens, based on the validated waste reduction data.

The waste reduction data may comprise an initial waste weight of the contents, which may comprise food, added to a receptacle of the waste reduction device and a completed waste weight of the contents, which may comprise dirt, of the receptacle of the waste reduction device after operation of the waste reduction device.

The method may further comprise writing, to a waste reduction token blockchain by a smart contract, a waste reduction token transaction dataset.

The waste reduction token transaction dataset may comprise the number of waste reduction tokens and a waste reduction device owner wallet identifier.

The waste reduction data may further comprise the waste reduction device owner wallet identifier.

The method may further comprise obtaining, from a user computing device associated with the waste reduction device, the waste reduction device owner wallet identifier.

The validating may further comprise:authenticating the waste reduction device; and applying one or more waste reduction data filters to the waste reduction data.

The receiving may occur shortly after the waste reduction device completes its operation.

There may be a system to perform the methods above.

There may further be a method for the creation of a waste reduction token, based on waste reduction by a waste reduction device, the method comprising: (a) receiving, from the waste reduction device manufacturer, a waste reduction device dataset; (b) validating, by a validator, the waste reduction device dataset; and (c) calculating a number of waste reduction tokens, based on the validated waste reduction device dataset.

The waste reduction device dataset may comprise a number of waste reduction devices, an operation period for each of the waste reduction devices, and a waste reduction per unit of time assumption.

The method may further comprise writing, to a waste reduction token blockchain by a smart contract, a waste reduction token transaction dataset.

The waste reduction token transaction dataset may further comprise one or more waste reduction token transaction datasets, each of the waste reduction token transaction datasets comprising the number of waste reduction tokens and a waste reduction device owner wallet identifier.

There may be a system to perform the methods above.

There may further be a method for the calculation of an environmental benefit of the operation of a waste reduction device, the method comprising: (a) receiving, from the waste reduction device, a waste reduction data; (b) validating, by a validator, the waste reduction data; and (c) calculating the environmental benefit, based on the validated waste reduction data.

The waste reduction data may comprise an initial waste weight of the contents, which comprises food, added to a receptacle of the waste reduction device and a completed waste weight of the contents, which comprises dirt, of the receptacle of the waste reduction device after operation of the waste reduction device.

The waste reduction data may further comprise one or more characteristics of the input waste and one or more characteristics of the output waste, wherein the characteristics comprise one or more of their moisture and their chemical composition.

The method may further comprise obtaining, from one or more of the waste reduction device, an app of a user of the waste reduction device, or using a location of the waste reduction device, an electricity source used to power the waste reduction device and a physical output sink for the contents of the receptacle after operation of the waste reduction device.

There is a household composting device having a housing and a composting region for receiving compostable waste material, the composting device further comprising: (a) a removable bucket positioned within the housing for receiving the compostable waste material; (b) a weight sensor assembly, communicatively connected to a processor, and configured to determine a weight of the composting device or the removable bucket; (c) the processor, communicatively connected to the weight sensor assembly, configured to: obtain a weight of the composting device or the removable bucket from the weight sensor assembly.

The weight sensor assembly may comprise one or more weight sensors, that operate together to determine the weight of the composting device and wherein the weight sensor assembly is disposed on one of a bottom surface of the composting device or a bottom of the removable bucket.

The household composting device may further comprise a heating mechanism that comprises a heating element located inside the housing and configured to heat the bucket when activated; and a grinding assembly configured to grind compostable waste material in the removable bucket.

The processor may be further configured to: determine an initial weight of the composting device or the removable bucket, taken with compostable waste material in the bucket and before a composting cycle has been performed; and get a final weight of the composting device or the removable bucket, taken after the composting cycle has been performed; and determine a weight reduction amount, based on the initial weight and the final weight.

The processor may be further configured to communicate a household composting device dataset.

There is also a household composting device having a housing and a composting region for receiving compostable waste material as physical inputs and having physical outputs after a composting cycle has been executed, the composting device further comprising: (a) a removable bucket positioned within the housing for receiving the compostable waste material; (b) a sensor assembly, comprising a set of sensors, communicatively connected to a processor, and configured to determine one or more characteristics of the physical inputs and physical outputs; and (c) the processor, communicatively connected to the weight sensor assembly, configured to communicate the one or more characteristics.

The physical outputs may comprise a solid waste output and a liquid waste output, which may have various physical and nutrient compositions.

The set of sensors may comprise at least one of a pH sensor, a CO2 sensor, a CO sensor, an O2 sensor, a CH4 sensor, an NPK sensor, a nitrous oxide sensor, an ammonia sensor, a TOC sensor for biodegradation sensing, a volatile fatty acid sensor, and one or more sensors to calculate the carbon/nitrogen ratio.

There is further a household composting device weight sensor assembly, to be operationally combined with a composting device, the composting device weight sensor assembly comprising: (a) a weight sensor assembly, communicatively connected to a processor, and configured to determine a weight of the composting device or the removable bucket; (b) the processor, communicatively connected to the weight sensor assembly, configured to: (c) obtain a weight of the composting device or the removable bucket from the weight sensor assembly.

The weight sensor assembly may comprise one or more weight sensors that operate together to determine the weight of the composting device and wherein the weight sensor assembly is disposed on one of a bottom of the composting device or the removable bucket.

A household composting device having a housing and a composting region for receiving compostable waste material as physical inputs and having physical outputs after a composting cycle has been executed, the composting device further comprising: (a) a housing, having a top surface, wherein the housing has a height such that the top surface is at the same height as a counter; and (b) a removable bucket positioned within the housing for receiving the compostable waste material.

The top surface may further comprise a lid that is hingedly attached to the household composting device to allow access to the removable bucket when in an open position.

The top surface may further comprise a lid that is slidably attached to the household composting device to allow access to the removable bucket when in an open position.

The household composting device may be installed in the middle of, and flush with, a countertop, such that the compostable waste material on the countertop can be wiped directly into the household composting device.

There is also a household composting device having a housing and a composting region for receiving compostable waste material as physical inputs and having physical outputs after a composting cycle has been executed, the composting device further comprising: (a) a housing, having a top surface comprising a lid, wherein the lid has a clear portion, allowing a user of the household composting device to view into the removable bucket when the lid is in a closed position; and (b) a removable bucket positioned within the housing and below the lid for receiving the compostable waste material.

The lid may further comprise a camera, mounted in the lid and configured to capture an interior of the removable bucket when the lid is closed.

The household composting device may further comprise a processor, communicatively connected to the camera, and wherein the processor is configured to obtain a video signal from the camera and transmit the video signal to a video signal sink.

The household composting device may further comprise a heating mechanism that comprises a heating element located inside the housing and configured to heat the bucket when activated; and a grinding assembly configured to grind compostable waste material in the removable bucket.

A household composting device having a housing and a composting region for receiving compostable waste material as physical inputs and having physical outputs after a composting cycle has been executed, the composting device further comprising: (a) a housing, defining an exterior of the household composting device; (b) a lid, on a top surface of the household composting device and configured to receive compostable waste material into the household composting device when in an open position; (c) a first grinding assembly, disposed below the lid and configured to receive the compostable waste material and grind it into ground compostable waste material comprising smaller pieces of compostable waste material; and (d) a removable bucket positioned within the housing and in the composting region, and below the first grinding assembly, for receiving the ground compostable waste material from the first grinding assembly prior to operation of the composting cycle.

The composting region may further comprise a heating mechanism that comprises a heating element configured to heat the bucket when activated; and a second grinding assembly configured to grind compostable waste material in the removable bucket.

A household composting device having a housing and a composting region for receiving compostable waste material as physical inputs and having physical outputs after a composting cycle has been executed, the composting device further comprising: (a) a housing, defining an exterior of the household composting device; (b) a lid, on a top surface of the household composting device and configured to receive compostable waste material into the composting region when in an open position; (c) a composting region; (d) a moisture capture assembly, attached to an outlet from the composting region, configured to direct and capture the moisture leaving the composting region with the outlet.

The moisture capture assembly may further comprise a diverter, which further comprises a diversion lip, configured such that when moisture comes out of the outlet the moisture collects on a bottom surface of the diversion lip, and wherein the diversion lip is directed such that moisture drips that fall from the diversion lip are directed into a water receptacle, and a water receptacle that collects the moisture drips which comprise a physical liquid output from the household composting device.

The household composting device may further comprise a heating mechanism that comprises a heating element configured to heat the bucket when activated.

The physical liquid output may comprise nutrients from the compostable waste material.

There is a household composting device having a housing and a composting region for receiving compostable waste material, the composting device further comprising: a housing, defining an exterior of the household composting device; a lid, on a top surface of the household composting device and configured to receive compostable waste material into the household composting device when in an open position; a bucket positioned within the housing and in the composting region, and below the first grinding assembly, for receiving the ground compostable waste material from the first grinding assembly prior to operation of the composting cycle; and a condenser assembly, configured to: facilitate an outlet air flow leaving the composting region via an air outlet; expose the outlet air outlet to a cooler air flow to cause the air flow to condense into a condensate and an inlet airflow; capture the condensate; and redirect the inlet airflow into the composting region.

There is also a system to perform the methods described above.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is an exemplary system for waste reduction token creation, validation and storage according to an embodiment of the present invention;

FIGS. 2-5 show methods for waste reduction token creation, validation and storage according to an embodiment of the present invention;

FIG. 6 is an exemplary system for waste reduction token creation, validation and storage according to an embodiment of the present invention;

FIG. 7 shows a method for waste reduction token creation, validation and storage according to an embodiment of the present invention;

FIG. 8 is an exemplary system for waste reduction token creation, validation and storage, based on various inputs and outputs for waste reduction devices, according to an embodiment of the present invention;

FIG. 9 shows a method for waste reduction token creation, based on various inputs and outputs for waste reduction devices, according to an embodiment of the present invention;

FIGS. 10a-d are exemplary placements of weight sensors according to an embodiment of the present invention;

FIGS. 11a-b are illustrations of an exemplary weight sensors according to an embodiment of the present invention;

FIG. 12 is an exemplary logical connection for a composting device, including user interface elements therefore, according to an embodiment of the present invention;

FIGS. 13a-b are illustrations of a form and dimensions for an exemplary composting device according to an embodiment;

FIGS. 14a-b are elements of exemplary composting devices, and features thereof, according to an embodiment of the present invention;

FIGS. 15a-d is an example exemplary lid assembly for a composting device according to an embodiment of the present invention;

FIGS. 16a-b are an exemplary steam diversion assembly for a composting device according to an embodiment of the present invention.

FIGS. 178a-b are elements of exemplary condensers for composting devices, and features thereof, according to an embodiment of the present invention;

FIG. 18 is an exemplary illustration of airflow through a condenser of a composting device;

FIGS. 19A-19D are shown exemplary scenarios that can be calculated, using available calculators (such as WARM and EPA calculators) for some of the calculations;

FIGS. 20A-20B, there are shown sample of calculations for aggregated scenarios.

### DETAILED DESCRIPTION OF THE PREFERRED EMBODIMENTS

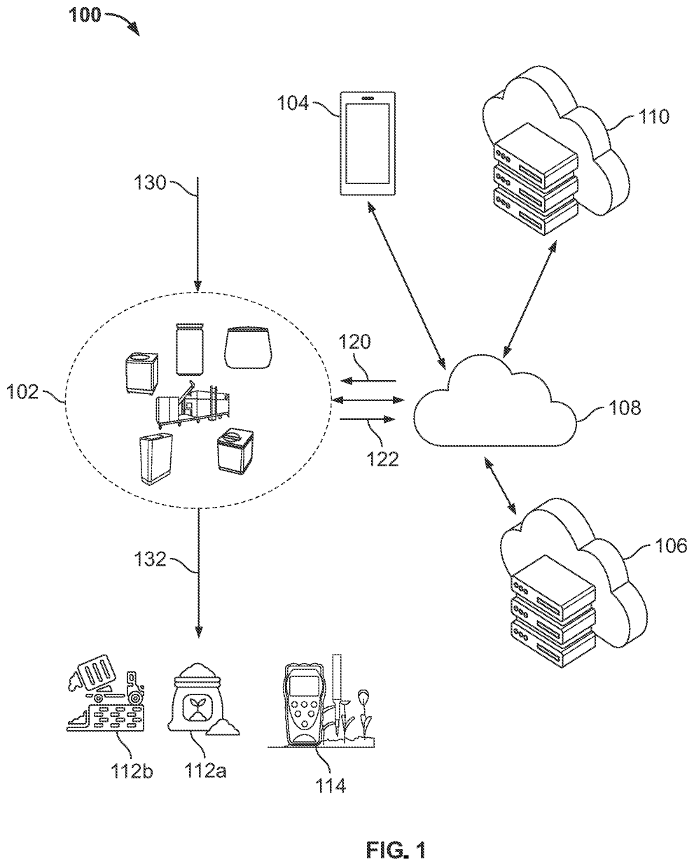

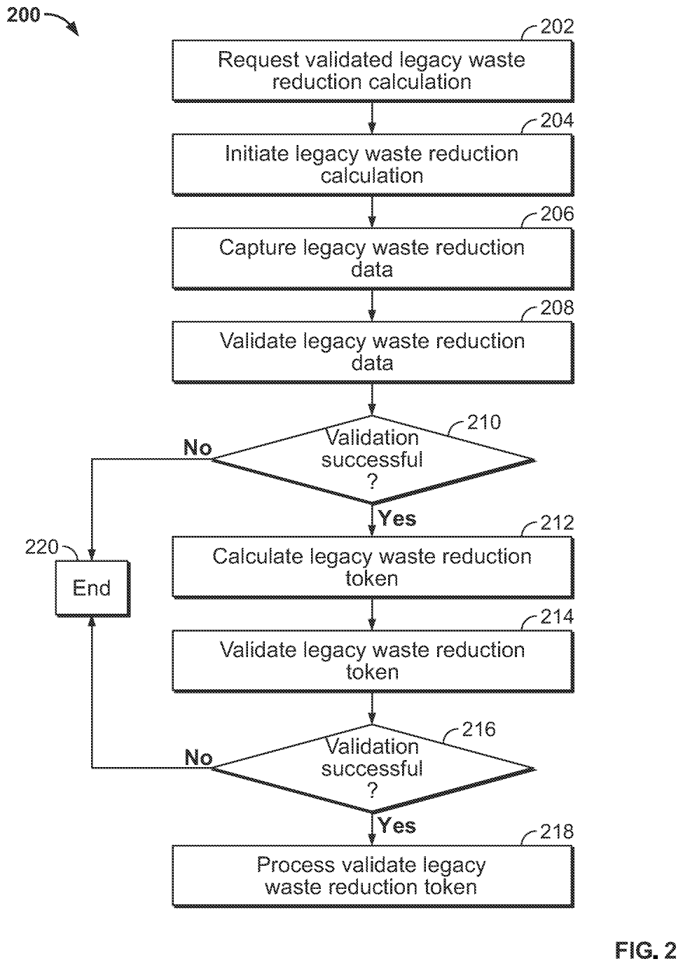

FIG. 1 is an exemplary system 100 for waste reduction token creation, validation and storage according to an embodiment of the present invention. System 100 comprises one or more waste reduction devices (WRD) 102, which receive waste reduction physical inputs (or “physical inputs”) 130 and waste reduction data inputs (or “data inputs”) 120, and provide waste reduction physical outputs (or “physical outputs”)132 and waste reduction data outputs (or “data outputs”) 122, waste reduction physical output sinks (or “physical sinks”) 112a/b, waste reduction physical output measurement devices (or “physical measurement devices”) 114, network 108, user computing devices 104 that is used by one or more user types, waste reduction device manufacturer servers 110 and waste reduction validator 106.

System 100 receives physical waste into a waste receptacle of WRD 102, as known. Additional inputs may also be provided, such as additives or other enhancers. WRD 102 is then operated, using other inputs to WRD 102 and according to operating parameters that are provided (such as by user computing device 104, manufacturer server 110 and validator 106) and tracked by WRD 102. Upon completion of processing, WRD 102 produces physical outputs and data outputs. Physical outputs are sent to physical sinks for end of life and measurements. Data outputs are sent, via network 108 for example, to one or more of computing device 104, manufacturer server 110 and validator 106 for validation and storage of various data elements of the output data, and optionally creation of a proof of waste token.

As such, system 100 allows, for example, food and compostable plastic waste (such as “Lomi Approved” bioplastic waste, or “bioplastics” or “certified compostable bioplastics) to be broken down into dirt (its weight substantially reduced, and its carbon or energy use reduced, for example), optionally using additives and according to various operating parameters and environmental operating conditions (such as the energy source, local climate, municipality, and the like), in WRD 102, with the physical output delivered to a physical sink 112 associated with the particular WRD 102, with the various data being captured, validated and stored.

In addition to weight reduction, pretreating certified compostable products upstream of physical sinks such as commercial compost facilities may provide practical and real-world advantages. For example, it can be difficult for compost manufacturers (entities that create compost that is then used) to recognize which products are certified compostable products. As a result, certified compostable products can be treated as conventional plastic contaminants and sorted or screened out of commercial compost facilities and sent to landfill, which is not a sustainable solution for compostable product manufacturers, compost manufacturers or consumers. Preconditioning certified compostable products in a controlled environment upstream of the compost facility (such as at residence or business), can help accelerate the disintegration and biodegradation rate of these products so they are not treated as contaminants at the compost facility and they end their life as compost rather than in landfill.

In one example, physical waste inputs include food and bioplastics. WRD 102 weighs and assesses the physical inputs and is set to operate, using renewable energy, according to operating parameters, such that the physical outputs can be optimally directed to the intended physical sink. Physical inputs and outputs, and data inputs, are distributed as data outputs to a user's app on a user computing device and to validator 106.

WRD 102 may have been operating for some time without quantifying, validating and storing data about waste reduction. WRD 102 may continue to operate in the future and it may be desirable to do so as operating continues. Where WRD 102 is able to, it may send waste reduction data to validator 106 substantially in real time as its cycle completes, or shortly thereafter. This may be in contrast to WRD 102 that are not able to communicate such data, such as those for which only estimated waste reduction data may be obtained and tokenized.

Some WRD 102 may not be able to communicate data, as they are currently. Such composting devices 102 may be retrofit with a waste reduction calculator assembly, as described herein.

Operating Parameters

Operating parameters for WRD 102 may be broken down into various categories, such as WRD settings, WRD operating parameters, WRD environment parameters, physical waste characteristics (weight at the start of a cycle, weight at the end of a cycle, etc.).

WRD settings: may include settings related to the device, such as operating modes (that determines how WRD 102 performs, for example), settings for a particular mode (such as settings for systems internal to WRD 102, such as heat system settings, motor RPMs, duration, and the like), time of day to operate, and settings to format the data, data target, and other settings (such as various IoT standards including Apple Homekit™, Bluetooth™ standards, and the like) to properly select and execute sending data to one or more of waste reduction validator 106, directly to a blockchain if WRD 102 is capable of doing so, or other data sinks—directly or indirectly) and the like.

WRD settings and operating parameters may be considered “on device specifications” (specifications that are accessible via physical interaction with WRD 102, such as using buttons to select a cycle and initiate operation, and the like) and “in device specifications” (specifications that are not accessible via physical interacting with WRD 102, though possibly via interaction via an app or WRD software/firmware changes, such as weight is to be measured in kg, dissipation in kilojoules, the selected IoT format, and the like).

WRD environmental parameters: may include parameters about the environment WRD 102 finds itself operating in. These may be determined or sensed automatically (such as by WRD 102 or by another part of system 100, such as validator 106) or may be specified by one or more parties, such as by a user using user app on user computing device 104. These may include a physical address of WRD 102, a sink for physical output, an electricity source for WRD 102, and the like.

Physical characteristics: may include characteristics about the physical input(s) and/or output(s). These may be determined or sensed automatically (such as by WRD 102 or by another part of system 100, such as validator 106) or may be specified by one or more parties, such as by a user using user app on user computing device 104. These may include the waste that is put into WRD 102 (apples, bones, chemical composition of waste, weights of inputs, additives, weights and compositions, dampness or moisture, and the like—generally being characteristics of the physical inputs, or content, put in a receptacle of WRD 102) and waste that may be removed from WRD 102 (compositions, weight, dampness or moisture, and the like, generally being characteristics of the physical inputs, or content (which may be dirt), left in a receptacle of WRD 102 after operation of a cycle of WRD 102), such as at the end of operation of WRD 102.

### Composting Device/WRD

Composting Device/WRD

WRD 102 may be one or more devices that receive physical waste, operate on the received waste, and then reduce the physical waste via one or more physical and/or chemical mechanisms, prior to outputting the physical waste.

WRD 102 may be able to interact with operating parameters, such as to receive and detect data inputs (such as to control its operation—mode/cycle selection, operating parameters, characteristics of the physical inputs and physical outputs, time of day for operation, and the like, as described herein) and store and/or distribute data outputs.

WRD 102 may also be designed to have various run cycles from a set of composting cycles—for example a “bioplastics approved cycle” or “Lomi™ approved cycle, an Eco cycle (also known as “grow cycle”), and an Express cycle (also known as “ecoexpress cycle”). The grow cycle and the ecocycle may each be exemplary “conventional cycles”—not particularly directed to or suitable for bioplastics or browns. The Lomi™ approved cycle may be for breaking down compostable waste material that includes at least some biopolymers (such as Lomi approved biopolymers that have been tested to ensure suitable breaking down via a composting device) and/or “browns”—natural fibre products. Each cycle may adjust operating parameters to provide for additional grinding for bioplastic, more grinding activity, higher temperature or for a longer time, that may be conducive to more effective breaking down of biopolymers and browns and hence a reduction of weight. Each cycle may have different phases, that may be of different lengths. For example there may be a drying phase, followed by a grinding phase, followed by a cooling phase.

WRD 102 may have one or more sensors (for example combined logically into a sensor assembly) that enable it to measure various characteristics (weight, moisture, make up of waste and the like) during its operation (for example at the start of operation and at the end of operation, to measure the change, or delta, waste as a result of operation. Such sensors may have various settings or parameters, for example what unit of measurement is to be used, how sensors communicate their sensed data, and the like. It may be preferable for such sensors to be able to be standardized, such that all WRD 102 are operating interchangeably, resulting in simpler validation and more reliable waste token data and a higher trust system 100.

Exemplary WRD 102 may include composting devices, such as Lomi composting devices—such as currently publicly available, as described in U.S. patent application Ser. No. 17/591,903 filed Feb. 3, 2022 and future versions as described in US provisional patent titled System and. Device for Composting, provided various features and components may be added thereto, to enable the functionality described herein—such as various sensors (including, for example, weight sensors), software on WRD 102, transceivers or other communications interfaces, and the like.

WRD 102 may have a unique ID, for example generated from the first five bytes of its MAC address, written in a hexadecimal format and the prefix “Lomi_ESP32_” or “WRDManuID_ESP32_”. Waste reduction device identifiers may also be associated, for example in an app on user computing device 104 or validator 106, with a wallet of an owner of WRD 102.

WRD 102 may store (directly or indirectly) various real time and historical information, such as operating parameters and other information. By way of example, the following information may be stored:

| Parameter name | Type | Comment |
|---|---|---|
| lomi_command | string | can take the following values: |
| | | “no_cmd” |
| | | “start” |
| | | “stop” |
| program_selected | int | from 1 to 3 |
| start_time | string | UNIX Epoch time |
| lomi_state | string | can be one of the following: |
| previous_state | string | “idle”, “stage1”, “stage2”, “stage3”, “error”, |
| | | “paused”, “finished”, “recovery” |
| error_name | string | can be one of the following: |
| | | ″NO_ERROR″, ″COVER_OPEN″, |
| | | ″HEATING_ELEMENT_FAIL″, |
| | | ″GRINDER_ROTOR_JAM″, |
| | | ″FAN_ISSUE″, |
| | | ″NO_BUCKET″, |
| | | ″NO_MOTOR_CURRENT″, |
| | | ″UNKNOWN_ERROR″ |
| sensor_data | string | String can be parsed by the following keys: |
| (S1 to Sn | | “S1” - sensor1 which returns humidity and |
| depending | | temperature from the bucket. Values are |
| on sensors) | | separated by “:”. |
| | | “S2” - sensor2 which returns ambient |
| | | humidity and temperature. Values are |
| | | separated by “:”. |
| | | HT - Heater temperature. |
| | | WT - the last measured LOMI weight. LOMI |
| | | may measure weight only in the beginning |
| | | and the end of cycle, so this value may |
| | | be relevant only with transition: |
| | | “previous_state”=”idle”,“lomi_state”=“sta |
| | | ge1” |
| | | and |
| | | “previous_state”=“stage3”,“lomi_state”=“f |
| | | inished” |
| | | Example: |
| | | ″S1(42%:53C) S2(46%:24C) HT(80.8C) |
| | | WT(11096)″ |
| | | Sensor reading time may be included with |
| | | the sensor reading. |
| | | Of course sensor_data may be any data |
| | | from any of the sensors described herein. |
| energy_last | number | The energy in joules(watts*second) |
| | | consumed during the last cycle. |
| | | This value is relevant only with transition: |
| | | “previous_state”=“stage3”,“lomi_state”=“f |
| | | inished” |
| runtime_last | number | the number of seconds the last complete |
| | | cycle took. |
| | | This value is relevant only with transition: |
| | | “previous_state”=“stage3”,“lomi_state”=“f |
| | | inished” |

WRD 102 may have a device shadow as well, for example that may be stored and accessible on an app on WRD 102 and provide a replication of WRD 102 itself:

```
  The device shadow may be represented in the following JSON
  format, as an example:
  {
    “state”: {
      “desired”: {
        “start_time”: “1632488157”,
        “program_selected”: 3,
        “lomi_command”: “no_cmd”
      },
      “reported”: {
        “lomi_command”: “no_cmd”,
        “program_selected”: 3,
        “start_time”: “1632488157”,
        “lomi_state”: “stage2”,
        “previous_state”: “error”,
        “error_name”: “NO_ERROR”,
        “sensor_data”: “S1(42%:53C) S2(46%:24C) HT(80.8C)
  WT(11096)”,
        “energy_last”: 834877,
        “runtime_last”: 7154
      }
    }
}
```

WRD 102 may be IoT enabled. This may enable a suite of commands for WRD 102, for example to interact with other components of system 100 (including user computing device 104, validator 106, and the like). Exemplary commands may include, start, stop, send data, change cycles, and the like, and may be as per the below:

Cycle change command
To change program the command in JSON format should be sent to the topic:
$aws/things/Lomi_ESP32_XXXXXXXXXX/shadow/update {“state”: {“desired”:{“program selected”: X}}}
Where X is a number from 1 to 3.

Start/Stop command
To send a command in JSON format should be sent to the topic:
$aws/things/WRD_ESP32_XXXXXXXXXX/shadow/update {“state”: {“desired”: {“lomi_command”: <CMD>} } }
Where <CMD> could be “start”, “stop” or “no_cmd”. Initial string should be “no_cmd” otherwise Lomi will either start immediately in the case of “start”, or goto the finished state if the command is “stop”.

Scheduled start command
To start at the particular time the command in JSON format should be sent to the next topic:
$aws/things/WRD_ESP32_XXXXXXXXXX/shadow/update
{“state”: {“desired”: {“start_time”: “NNNNNNNNNN”}}} Start time string is a number of seconds from the start of the UNIX epoch. It should be bigger than the timestamp of the latest shadow update. If the string is empty or the number in the string less than timestamp of update, this parameter is ignored and Lomi will not use it to start.

Cycle completion criteria in AWS
WRD 102 successful cycle completion can be determined by shadow transition into “finished” state from “stage3” state. The corresponding shadow fields should be the following:
“previous_state”=“stage3”,
“lomi_state”=“finished”
In case of incomplete cycle or cycle completed with an error, WRD 102 shadow transitions into “error” state. In that case, the field “error name” will contain the error name.

In operation, a user may fill WRD 102 with organics. A user may select a cycle for WRD 102 to perform to reduce the waste's weight. WRD 102 may take an initial weight of WRD 102 or removable bucket with its waste contents. Such weight may be after additives, and any other items are added, for example. After the cycle is complete WRD 102 may take a final weight, and then subtract the initial weight to arrive at a weight reduction amount. As part of IoT functioning, WRD 102 may assemble a a household composting device dataset—which may comprise information such as the initial weight, final weight, weight reduction amount, additives used, information about the waste that was added, date/time, cycle(s), energy used, and the like.

Physical Inputs and Outputs

Physical inputs may be anything physical that is an input to WRD 102. Such may include the waste (food, bioplastics), additives, electricity, and the like.

Data Inputs

Data inputs may be any data that is an input to WRD 102. Such may include operating parameters, as described herein.

Physical Sinks

Physical sinks may include any locations where physical outputs will be directed—such as backyard composters, landfills, industrial or municipal landfills, soil, garden, lawn, animal feed/food, and the like.

Physical Measurement Devices

Physical measurement devices may be devices that measure one or more of physical inputs or physical outputs. Such devices may measure various features, such as weight, chemical composition, presence of gases versus solids, moisture, and the like.

Communication Network

Communication network 108 may be substantially any one or more public or private network, wired or wireless, and may be substantially comprised of one or more networks that may be able to facilitate communication between the various elements of system 100. Network 108 may be a collection of network devices and methods of communicating, including one or more third party services and/or one or more servers (such as webservers) that may be owned by one of the parties operating system 100.

User Computing Devices

User computing device 104 may allow a user to interact with system 100 and WRD 102, for example via apps installed thereon. Examples of user computing devices 100 include, but are not limited to, smartphones and other personal devices (such as watches, heart rate monitors and the like), tablets, person computers, and the like. UCD 104 may have one or more apps running thereon, such as an app associated with one or more WRD 102. UCD 104 may be part of an enterprise collection of devices and/or enterprise applications. Apps may allow a user to set, store, review and configure various operating parameters.

Waste Reduction Validator

The validator, or validation server 106, may comprise one or more hardware components including computers, data storage, processors and the like and one or more software components including applications and database components. Parties and technologies such as Chain.Link, Oracle Network, and 3rd Party Services (including blockchains) may perform such services, or validation server may be a stand alone server or process.

Validator 106 may receive data outputs and perform various validations on such data outputs.

Validator 106 may store, or initiate the storing of, various data outputs.

Validator may initiate, or perform, various calculations using the data outputs—before or after validation.

Manufacturer Servers

The validator, or validation server 106, may comprise one or more hardware components including computers, data storage, processors and the like and one or more software components including applications and database components.

Manufacturer servers 110 may be owned and/or controlled by a manufacturer of WRD 102 (or similar party, such as a distributor) that wants to store validated waste reduction data in system 100. Manufacturer server 110 may be involved for legacy waste reduction tokens but may not be involved for that manufacturer's WRD 102, assuming such WRD 102 are IoT devices.

Manufacturer servers 110 may provide various data inputs, for example to quantify legacy waste reduction tokens.

Manufacturer servers 110 may provide various data outputs, for example to store legacy waste reduction tokens.

FIGS. 2-5 show methods 200, 300, 400, for waste reduction token creation, validation and storage according to an embodiment of the present invention. Methods 200, 300 and 400 may be particularly aimed at legacy waste reduction tokens and interactions with legacy WRD 102 owners. Legacy waste reductions tokens may be those that have already been achieved (i.e. waste already reduced) and for which real time, or fully transparent or quantified data (such as via an appropriate, and IoT enabled WRD 102), may not be available. Of course any given WRD 102 may simply be assigned a predetermined quantity of waste reduction tokens, for example if increased accuracy of the legacy waste reduction data is not possible or desirable.

Method 200 begins at 202 where a request is made to validate legacy waste reduction data. This may be via manufacture server 108 sending a request to validator 106.

This request may result in initiation at 204. Of course, the requester (such as manufacture server 108 may be validated first, such as to ensure they are on a list of approved manufacturers—whose WRD 102 may be subject to further validation).

At 206 legacy waste reduction data may be captured. This may be accomplished by working with WRD 102 manufacturers, who may also work with their customers.

This may involve one or more of the following items of legacy waste reduction data, such as below and as otherwise described herein:

| Item | Description |
|---|---|
| Number of WRD | Number of WRD in use, including date of first |
| | use. |
| Waste reduction | Waste reduction per use of WRD. This may be |
| per use/cycle | based on the weight of inputs for a cycle, for |
| | example, and may be based on the volume of |
| | material put into WRD 102 - and some related |
| | assumptions. |
| Uses or cycles | Number of uses of WRD. May be estimated, and |
| | may be on a “per WRD” basis and quarterly |
| | basis (ie number of quarters, or months that |
| | WRD 102 has been owned), for example. This |
| | may be used with other data to arrive at a “waste |
| | reduction per unit of time assumption” - WRD |
| | 102 being in normal use produces X amount of |
| | waste reduction per day/month/quarter, etc. |
| Waste type(s) | Nature of the waste being processed. |
| Physical sink | Any reliable, and ideally macro, information |
| information | about sinks. |

At 208 the captured data may be validated. This may be accomplished by applying one or more data validation tools and calculations (such as claims regarding waste reduction per cycle based on engineering reviews of the cited WRD 102, and the like, which may be exemplary waste reduction data filters), collecting and reviewing underlying data (such as sales and delivery data to validate first date of use, and the like), and performing user validations (such as contacting consumers to collect or validate their use data).

At 210 the captured data is either validated, or not (resulting in method ending at 220, or optionally re-starting). Validation at 210 indicates that the legacy waste reduction data appears to be valid and can be reliably used to calculate waste reduction tokens.

Validator 106 may work with manufacturer server 108 and user app(s) to perform 206-208, with validator 106 performing validation at 208-210.

Method 212 then continues to 212 where a legacy waste reduction token calculation is performed. This may involve taking validated legacy waste reduction data and providing it to a smart contract that calculates an associated number or amount of waste reduction tokens.

At 214 the calculations are validated. This may be done by validator 106 or a smart contract. Such validations may be similar to, or partly duplicative of, validations at 208. However, the focus at 214 is to ensure that, assuming the data is valid, the token calculation is done properly.

If successful, and the legacy waste reduction token calculation is validated then method 200 continues at 218 where such is processed. This may include storing the legacy waste reduction token calculation for the particular manufacturer or set of WRD 102.

Of course, it is to be understood that method 200 may be performed, in series or parallel, for various types of waste reductions tokens (such as waste, energy savings, and carbon savings). Method 200 may be initiated by a manufacturer who wants their WRDs 102 to participate in system 100.

Method 200, to determine legacy waste tokens or waste tokens for WRD 102 that either not able to measure waste reduction or are not IoT-enabled, may also be applied more simply. For example, manufacturer 110 may have a register of WRD 102, which may include owner names and delivery dates. Then a load study may be conducted, to determine max waste reduction and min waste reductions for a given time period. This may be done via surveying a sample of the owners of the set of WRD 102. Based on the survey results a “waste reduction per period of use” may be determined, and then applied to the set of WRD 102, for the periods of each WRD's 102 use period.

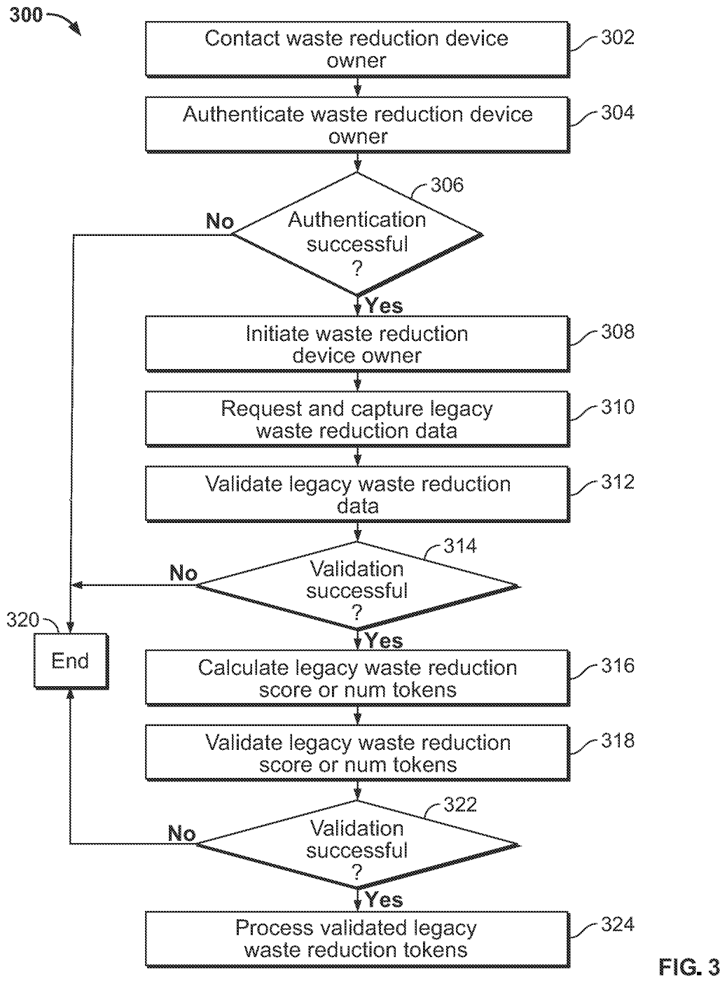

Turning to FIG. 3, there is a method 300 for waste reduction token creation, validation and storage according to an embodiment of the present invention. Method 300 may be aimed more particularly at doing so for an individual WRD 102, for example with a party (such as manufacturer) contacting each owner of its WRDs 102. Method 300 may be performed for an individual owner, a set of owners, and may also be used as part of 206 in method 200, to collect legacy waste reduction data.

At 302 WRD 102 owner may be contacted. This may be to ask if they wish to participate and provide legacy waste reduction data. This may be accomplished, for example, via an app that the user has downloaded on their user computing device 104.

At 304 the owner is authenticated, to ensure the purported owner is the current owner of WRD 102. This may be accomplished in various ways, depending on the capabilities of WRD 102, data available to the manufacturer, and the like. In one example, an app requests the owner to enter a unique WRD 102 identifier (device ID) and other details about the transaction pursuant to which the user purchased WRD 102. In more advanced examples, WRD 102 usage data may also be used to authenticate (such as by collecting an IP address for data sent from WRD 102, and cross-referencing that with physical address information for where WRD 102 was sent). In a further example of authentication, owners are contacted (for example via email) and are told they can download the app so they can be validated and then receive particular benefits. When they initially install or run the app the authentication information can be requested.

At 306 a query is made whether authentication is successful. This may involve confirming that the WRD ID matches what was sent to the user, and that other transaction details match. If not authenticated method 300 may end at 320.

If authentication is successful, then at 308 the owner may be initiated. This may be akin to setting up their profile in an app, for example.

At 310 a user is asked for their legacy waste reduction data. This may be, for example, via one or more questions asked through the app. A user may be asked about their historical use of their WRD 102—what do they typically put in, how often do they run it, where do they put the output, what municipal services are available to them (if their output goes there), what cycle(s) do they use, how many people are in their household contributing to the waste put in WRD 102, what is their source of electricity for running their WRD 102, and the like.

At 312 and 314 the provided legacy waste reduction data is validated. This is to ensure that the provided data has not been falsified or gamified to receive enhanced benefits (where benefits may be based at least in part on legacy waste reduction data for the user). Validation at 312 and 314 may be similar to validation at 208 and 210 but may also include validation based on responses to the user questionnaire. For example, if the household has one person and they indicate they run the WRD 102 three times a day, each of the 365 days they've owned WRD 102 then the credit they are given may be reduced to a more conservative amount based on their household, and other questionnaire responses. As another example, if the user indicates their output goes to an industrial composting facility but none exists in the validated location of WRD 102 then any benefits attributable to an industrial composting facility may be withheld.

Method 300 at 316/318/322/324 may be similar to method 200 at 212/214/216/218, provided that the approach may be specific to an individual owner of WRD 102.

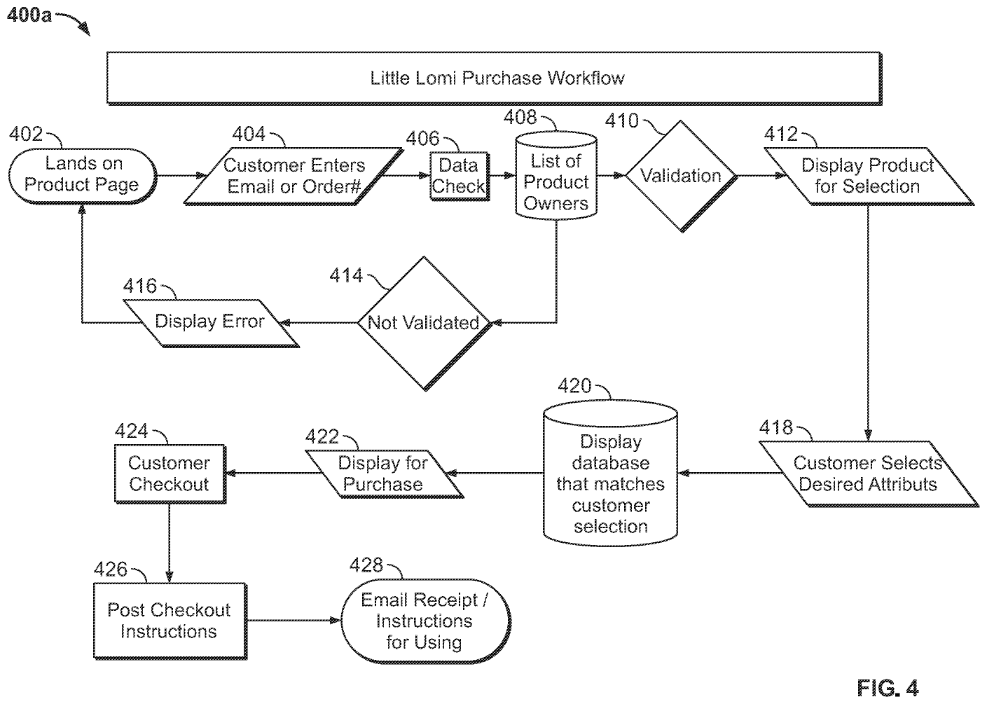

Turning to FIG. 4 there is a method 400a for aspects of waste reduction token creation, validation and storage according to an embodiment of the present invention. Method 400a may be aimed more particularly at a method to authenticate an existing/legacy WRD 102 owner (where at least some operation of WRD 102 has occurred prior to starting to calculate its waste reduction), such as method 300 at 302/304/306, and possibly for WRD 102 that are not IoT devices.

At 402 an owner visits a particular website (such as using user computing device 104) and enters their order number, or other identifying information, at 404. At 406 in a database at 408. At 410 if the validation is not successful then the user is not validated at 414 and an error is displayed to the user at 416, such as on user computing device 104.

At 412 a good for purchase may be presented, such as an NFT, that may provide enhanced benefits to a user. At 418, 420, 422, 424, 426 and 428 various processes may be performed. Method 400a, beyond 410, may be optional and ancillary to the desire to authenticate a user.

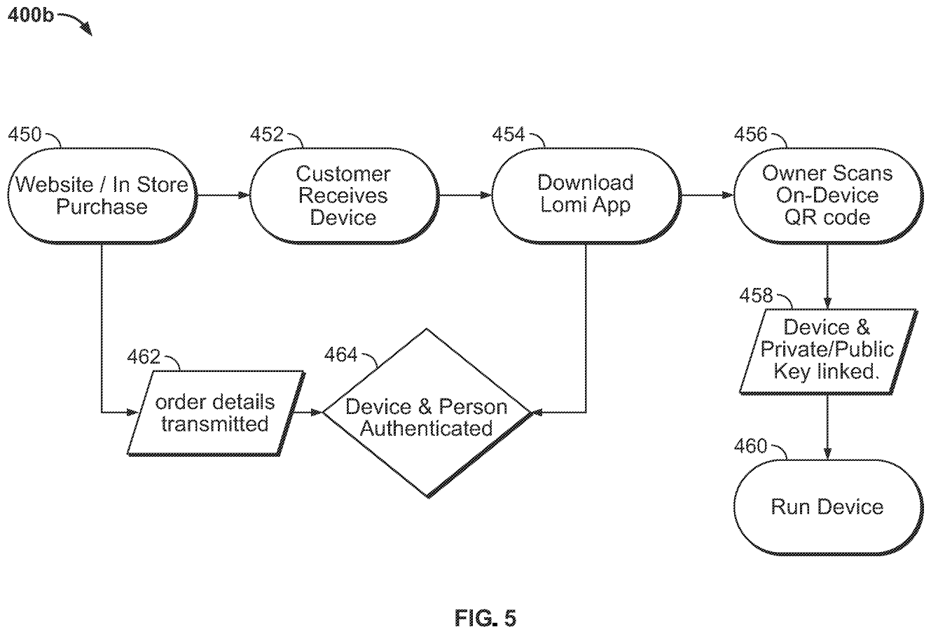

Turning to FIG. 5 there is a method 400b for aspects of waste reduction token creation, validation and storage according to an embodiment of the present invention. Method 400a may be aimed more particularly at a method to authenticate a new WRD 102 owner, such as method 300 at 302/304/306, and a WRD 102 that is an IoT device.

Method 400b begins at 450 where WRD 102 is purchased by a user, it is received by the user at 452 and the user downloads a WRD 102 app for their user computing device at 454. At 456 the user uses the app to identify the WRD 102 they purchased. This may be, for example by scanning a feature of WRD 102 (such as a QR code, barcode, or WRD identifier) or entering such information (such as a WRD identifier or serial number).

Method 400b may, in parallel to 452/454/456, transmit order details such that, at 464, WRD 102 and a user may be authenticated with the information captured at 456.

At 458 WRD 102 may be linked with public/private keys, which may involve establishing a crypto wallet associated with WRD 102 and/or the user. Of course if a user already has a crypto wallet on their user computing device then the app can provide prompts to synch with that wallet(s).

WRD 102 can then be used at 460, and methods for creating waste tokens, as described herein, may begin. Of course if authentication fails then further attempts may be made, or a different approach (such as in 400a) may eventually be followed.

It is also to be understood that method 400b addresses authenticating WRD 102 to the network and a user. There may also be a separate, and likely offline, process to test and validate performance of WRD 102 (for example to ensure accurate sensors and data, resulting in accurate waste token calculation and creation).

Ideally a user may only have to download and log in to the app, and then scan a QR code, to begin using system 100. These few steps may associate WRD 102 with them, their app, and/or one or more wallets on/in the app or user computing device.

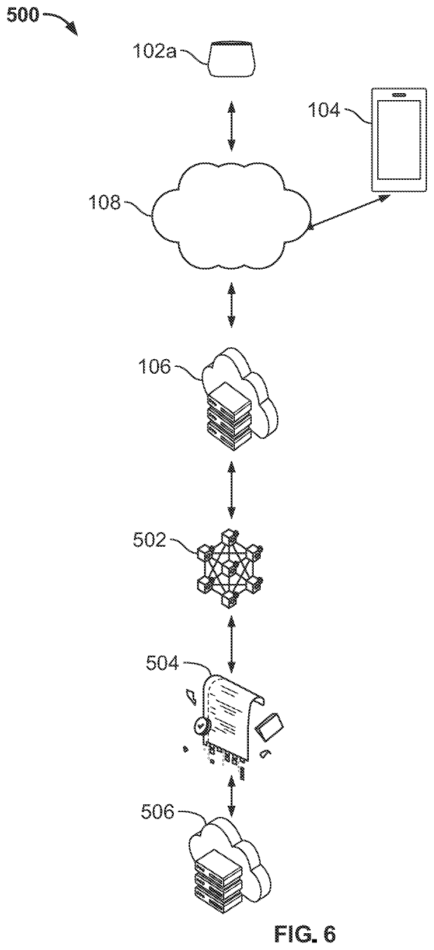

FIG. 6 is an exemplary system 500 for waste reduction token creation, validation and storage according to an embodiment of the present invention. System 500 may share similar components as in system 100, with the addition of connector 502, smart contract 504 and blockchain API 506.

System 500 allows waste reduction tokens to be automatically created, validated and written to the blockchain.

WRD 102a may be substantially as described herein, provided that WRD 102a has the required sensors to determine the waste data (waste inputs, waste outputs, and the like) to be able to provide, and validate, required data. In one embodiment, WRD 102a has sensors to weigh waste inputs, for example at the start of a cycle, and waste outputs at the end of the cycle, such that delta weight can be captured.

Connector 502 enables communication of data between validator 106 and the smart contract. Connector 502 may be an Oracle or SaaS tool, such as ChainLink or Flux Oracles or a node as a service 3rd party, to write output of calculations to blockchain smart contract. Of course a proprietary solution to create a node and write to a smart contract could be used, if desired. Connector 502 may be separate or may be essentially part of the same element of system 100.

Blockchain smart contract 504 may be a smart contract that determines waste reduction tokens based on data (which may be considered a waste reduction token transaction dataset) received from validator 106. For example, 1 kg of validated waste reduction may lead to 1 waste reduction token. As another example, 1 tonne of CO2e emissions reduced may be 1 waste reduction token (which may be the same token or a different token from the 1 kg of waste—a CO2e waste reduction token). The waste reduction token may be directly written to the blockchain, at the time of its validation, or it may be deferred.

Waste reduction tokens may include the following waste reduction token data: number of tokens, WRD ID, date, weight start, weight end, owner, input information, output information, output sink, bioplastic quantity, bioplastic identifier(s).

Blockchain smart contract 504, which may include a blockchain referred to as a waste reduction token blockchain, may be based on one of several underlying blockchain technologies, such as Polygon or Algorand.

Blockchain API or connector (which may be, or leverage, a block explorer, with query abilities, or the like) 506 may allow displaying of on chain information in a web app, an app on WRD 102, or some other sink of information. Although optional, blockchain API may increase the transparency of waste tokens, and may allow access to the underlying data. For example, queries may allow the display of token information, and other information, to a user of system 100.

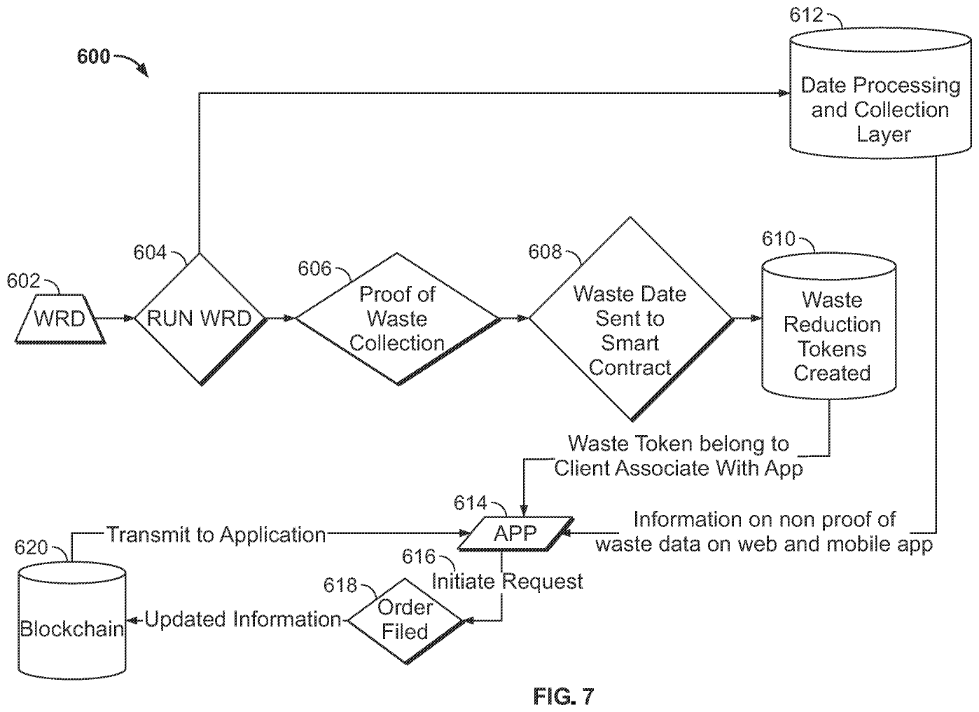

FIG. 7 shows a method for waste reduction token creation, validation and storage according to an embodiment of the present invention. Focusing on one WRD, method 600 begins at 602 where there is a WRD 102, such as WRD 102a. WRD 102 is run at 604 and at 606 proof of waste data is collected. In parallel, at 612, other data may be collected (for example that is not needed for waste reduction token processes). At 608 the waste reduction data collected at 606 (which may be a simple waste reduction token dataset that comprises waste reduction device owner wallet identifier that identifies the wallet address of the owner of WRD 102, such as WalletAddress=xxxxxx, NumTokens=1.5) is sent to a smart contract and at 610 waste reduction tokens are created and a user of an app on WRD 102 can view the tokens, associated with their WRD 102, on chain. The smart contract ensures validator is proper and trusted, and executes the smart contract based on the received and validated data. At 618 an order may be made to write the created tokens to the blockchain at 620. Method 600 then end, until WRD 102 is run again. Of course blockchain 620 may be accessed, via blockchain explorer 506, to review the token information.

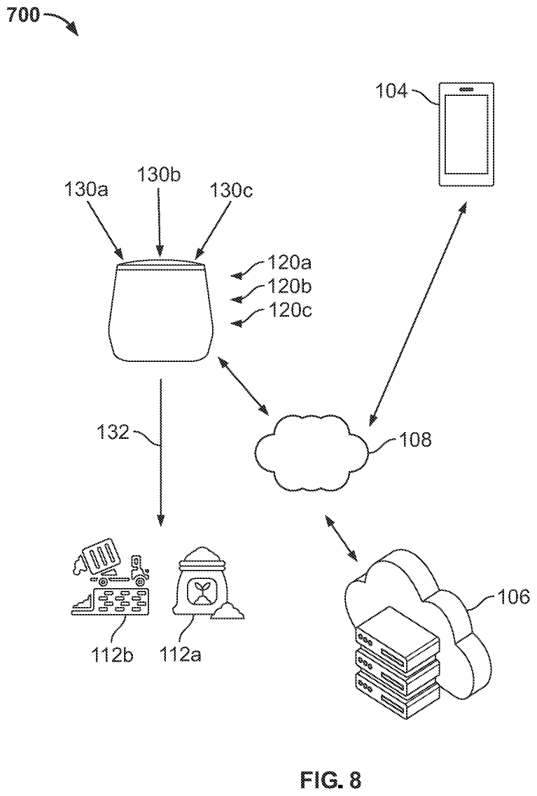

FIG. 8 is an exemplary system for waste reduction token creation, validation and storage, based on various inputs and outputs for waste reduction devices, according to an embodiment of the present invention. System 500 may share similar components as in system 100.

System 700 allows for increased accuracy in the calculation of waste reduction—and in particular for CO2e waste reduction. In particular for bioplastics, system 700 may allow for determination and quantification of end of life for certain bioplastics.

System 700 comprises physical inputs 130a, 130b and 130c and data inputs 120a, 120b, and 120c. It is to be understood the further, or fewer, physical inputs and data inputs may be involved.

Physical input 130a may be the food materials that are input into WRD 102 for processing, which may include a weight and other properties. Physical input 130b may be bioplastics (such as WRD approved bioplastic products, bioplastic products that have been tested to break down in a particular WRD—“approved products”) that are put into WRD 102 for processing and may include weight and other properties. Such inputs may be set via UCD 104 (and thus also a data input, such as 120c) or sensed via sensors in WRD 102. In particular, WRD 102 may sense the presence of an approved product, via machine learning, QR codes, and the like, including using one or more cameras. Physical input 130a may be the source of energy for WRD 102 (including both the energy itself and acknowledgment of the source of the energy, which may be a data input 120), and may include renewables or validated carbon offsets.

Input 120c may be one or more pieces of sink data that enables determination, such as by app or validator 106 or on UCD 104, where the physical output 132 of WRD 102 is going to go (i.e. which physical waste sink 112). A user may indicate, via the app, that they will use physical waste output 132 in their garden or in their outdoor home compost. If not specified by a user then 130c may be information about the location of WRD 102 (such as an address or city, generated by an IP address or location of WRD 102) that allows a determination of a waste sink 112. For example, if the IP address of WRD 102 is in a city that collects compost and is known to reliably put the collected compost in an industrial compost then an industrial compost is registered as sink 112. If there is no compost then sink 112 would be a landfill. Of course further information may be used to arrive at accurate waste reduction data, such as information about the transportation practices of a given municipality or city, which may reduce the amount of waste or CO2e created in the end of life of physical outputs 132.

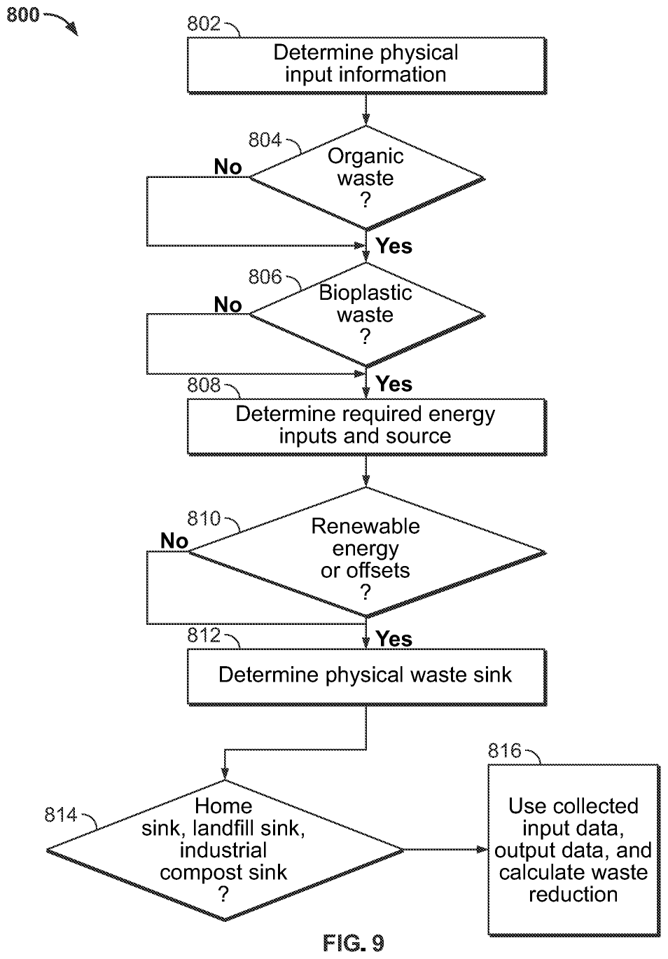

FIG. 9 shows a method 800 for waste reduction token creation, based on various inputs and outputs for waste reduction devices, according to an embodiment of the present invention.

Method 800 begins at 802 to determine physical input information—what is being put in WRD 102 for processing. At 804 a query is made whether organic waste is involved and at 806 a query re bioplastics. In any event, the information is stored.

At 806, if bioplastics are being input for processing a further method may be carried out to determine what product(s) are being put in, so that end of life data may be determined for the given bioplastic device and/or bioplastic manufacturer and/or bioplastic user/consumer. This may allow such bioplastic product to be tracked from creation, through initial sale, to end of life at a physical output sink.

At 808 the energy sources are determined, for example via a query at 810 whether renewable energy sources are used, carbon offsets have been purchased, coal or other fossil fuel based energy is being used. This determination may be for WRD 102 but may also be for, for example, how physical output 132 are being transported to their sink.

At 812 a physical waste output sink is determined. This may be as described herein, and involve requesting information from a user and/or detecting and determining the sink—where at 814 various sink options are considered.

At 816 the collected input information, along with output information as described herein, is used to calculate waste reduction. For example, the main data for the waste calculations may be weight in, weight out and how often are using it, and in what mode. then if we want to add carbon credit calculations we would need to collect weight in, weight out, how often they are using it, in what mode, location of lomi (for base power load emissions), where are they putting the end product (backyard, organics waste collection bin (green bin), or landfill).

Referring now to FIGS. 19A-19D, there are shown exemplary scenarios that can be calculated, using available calculators (such as WARM and EPA calculators) for some of the calculations.

Referring now to FIGS. 20, there are shown sample of calculations for aggregated scenarios. In the below, a given city or area (even a neighborhood or particular “route” that a garbage truck might drive) might be studied to assess the benefits if one or more of the sources of waste (households, restaurants, venues, businesses, and the like) have WRD 102. As such it may be possible to quantify benefits across various groups, and each grouping may experience different factors (for example those on a single garbage truck run may be able to entirely eliminate a weekly garbage run, resulting in bi-weekly runs, or lighter weight runs).

Physical outputs 132 may include the contents of the removable bucket at the end of the cycle(s) and/or other physical outputs, such as any liquid outputs (such as condensate) that may be collected in a condenser or water reservoir 626 and may include nutrients extracted from the waste and/or additives as a cycle is performed.

Data Inputs

Data inputs may be any data that is an input to WRD 102. Such may include operating parameters, as described herein.

Physical Sinks

Physical sinks may include any locations where physical outputs will be directed—such as backyard composters, landfills, industrial or municipal landfills, soil, garden, lawn, animal feed/food, and the like.

Physical Measurement Devices

Physical measurement devices may be devices that measure one or more of physical inputs or physical outputs. Such devices may measure various features, such as weight, chemical composition, presence of gases versus solids, moisture, and the like.

Communication Network

Communication network 108 may be substantially any one or more public or private network, wired or wireless, and may be substantially comprised of one or more networks that may be able to facilitate communication between the various elements of system 100. Network 108 may be a collection of network devices and methods of communicating, including one or more third party services and/or one or more servers (such as webservers) that may be owned by one of the parties operating system 100.

User Computing Devices

User computing device 104 may allow a user to interact with system 100 and WRD 102, for example via apps installed thereon. Examples of user computing devices 100 include, but are not limited to, smartphones and other personal devices (such as watches, heart rate monitors and the like), tablets, person computers, and the like. UCD 104 may have one or more apps running thereon, such as an app associated with one or more WRD 102. UCD 104 may be part of an enterprise collection of devices and/or enterprise applications. Apps may allow a user to set, store, review and configure various operating parameters.

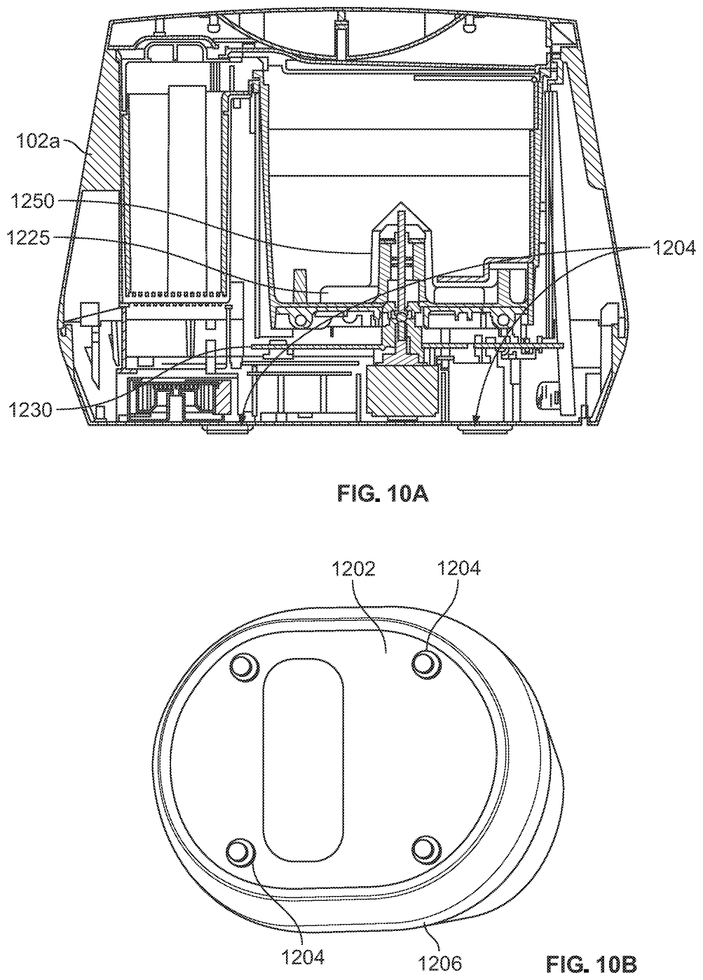

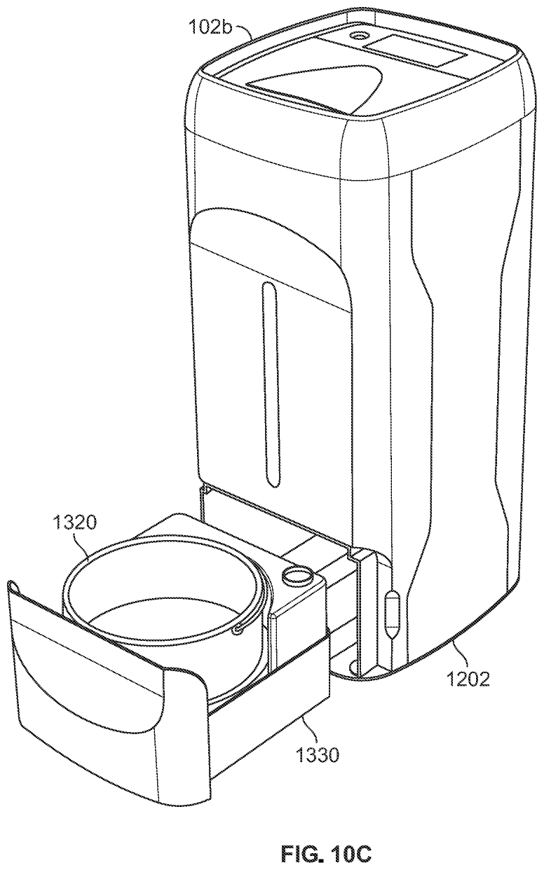

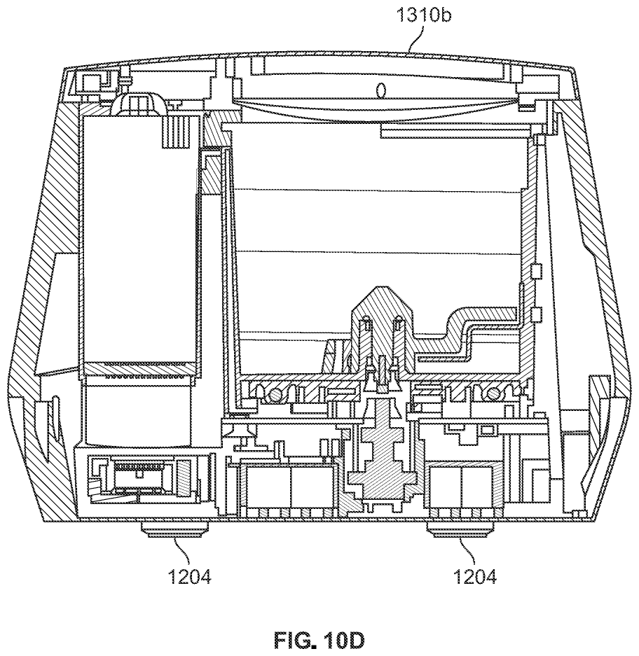

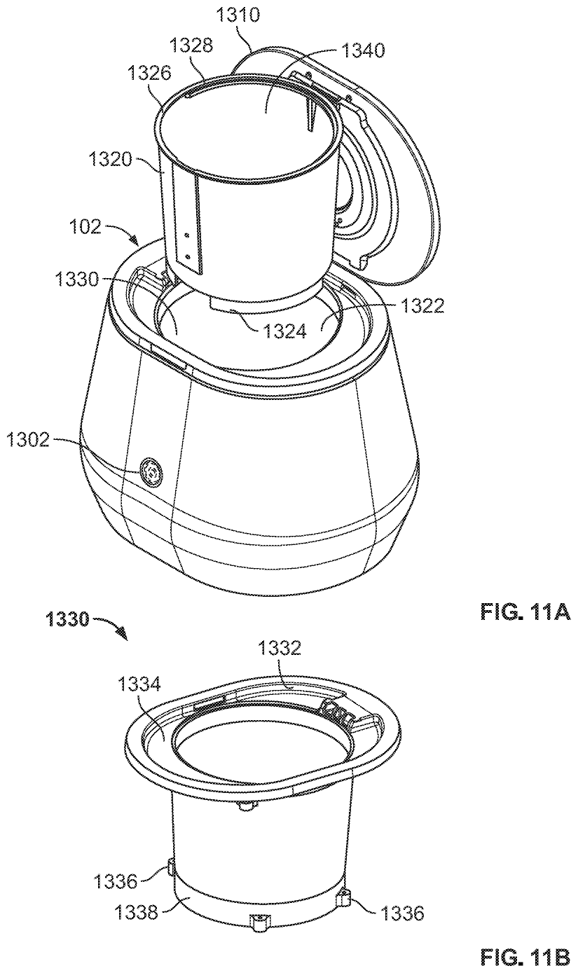

FIGS. 10a-c are exemplary placements of weight sensors 1204 for composting device 102a and composting device 102b according to an embodiment of the present invention.

FIG. 10a is a side view of composting device 102 a comprising weight sensors 1204. As shown weight sensors (load cell) 1204 may be located on the bottom of composting device 102a and extend slightly downward from a bottom surface of composting device 102a.

Weight sensors 1204 maybe one of several sensor types as known to those of skill in the art. For example, weight sensors 1204 may be TAL107H from HT Sensor Technology Ltd., rated for 10 kg.

FIG. 10a further comprises heating mechanism 1225 and grinding mechanism 1250. Heating mechanism 1225 comprises a base plate and a heating element. When activated the heating element 1230 heats base plate which heats the base, or bottom surface, of the removable bucket. Grinding mechanism 1250 includes multiple grinding blades rotated by a gear that is driven by a motor and gearbox. The grinding mechanism 1250 further includes an L shaped plate defined to have an arm positioned and secured along a groove in the bucket. The movement of the blades helps grind the waste in the bucket.

FIG. 10b is a bottom view of composting device 102a, showing weight sensors 204. Although four weight sensors 204 are shown in FIG. 2b any number of weight sensors may be used depending on the sensors selected the size and shape of composting device 102a and other factors.

FIGS. 10c-10d is an illustration of composting device 102b comprising bottom surface 1202 bucket assembly 1320 and bucket receptacle 1330. Similar to composting device 102a in FIG. 9a, composting device 102b may have one or more weight sensors 1204 located on bottom surface 1202 of composting device 102b. Weight sensors 1204 located on bottom surface 1202 may perform substantially similarly to weight sensors 1204 shown in FIG. 10b.

In another embodiment, there may be a weight sensor platform that is separate from a WRD 104 but is rather designed to be retrofit to a legacy WRD 102 that is not currently able to provide weight information. Such a weight sensor platform may be configured to fit WRD 102 thereon or therein and may comprise envelope 1206 that has bottom surface 1202 as well as weight sensors 1204. In such a case, weight sensor platform may have the various electrical systems described herein that may allow weight measurements, and possibly communications, to be provided.

Turning to FIGS. 11a-b there are further illustrations of an exemplary weight sensor 204 according to an embodiment of the present invention.

Looking first at FIG. 11a there is a composting device 102 comprising user interface assembly 1302, lid assembly 310a, bucket assembly 1320, and bucket receptacle 1330. Although composting device 102 in FIG. 11 a appears to be similar in shape and size to composting device 102a, it is to be understood that composting device 102 in FIG. 3a may be any number of form factors both as described herein and as known to those of skill in the art.

Bucket 1320 comprises a bucket cavity 1340, bucket bottom 1322, bucket base 1324, bucket lip 1326 and bucket handle 1328.

Bucket 1320 has a cavity 1340 where waste for composting may be received prior to composting activities being performed by composting device 102.

Bucket bottom 1322 maybe a bottom surface of bucket 1320 and may be configured to fit and interact with bucket receptacle 330 as may be required for performance of composting device 102. In addition, bucket bottom 1322 may have bucket base 1324 which may otherwise be known as bucket flange 1324 which may be configured to assist bucket 1320 in properly being secured or connected to bucket receptacle 1330.

It is to be understood that bucket bottom 1322 and bucket base flange 1324 may be designed, along with bucket receptacle 1330 and components thereof, to allow both bucket 1320 to be secured in bucket receptacle 1330 and also to facilitate alternative locations for weight sensors 1204 to be placed. For example, instead of weight sensors 1204 being placed on the bottom surface of composting device 102 weight sensors 1204 may be located on the bottom surface of bucket 1322 on bucket flange 1324 or on an interior bottom surface of bucket receptacle 1330.

Bucket receptacle 1330 may be configured to receive bucket 1320. Bucket receptacle 1330 may further comprise one or more receptacle edges or lips 1332 and receiving features 1334 which may be configured to interact with bucket lips 1326 to place bucket 1320 properly in bucket receptacle 1330. Bucket receptacle may further comprise one or more receptacle stands/legs 1336 and lower ring 1338. Both receptacle legs 1336 and lower ring 1338 may be locations for placement of one or more weight sensors 204 and receptacle legs 1336 may be disposed on lower ring 1338.

In use, bucket 1320 may be held by its handle when outside of bucket receptacle 1330. A user may then place bucket 1320 inside bucket receptacle 1330 at which point one or more weight sensors 204 may be engaged and provide a weight measurement. Such a weight measurement maybe indicative of a bucket 1320 that is full of waste or that is empty, as determined as described herein.

Bucket lip 1326 maybe extend outwardly from a top portion of bucket 1320 and may be configured so that it is resting on bucket receptacle 1330 (and, for example, receptacle edges 1326 or receiving features 1334) when bucket 1320 is located inside composting device 102. Bucket handle 1328 may allow bucket 1320 to be removed from bucket receptacle 1330 for example by a user's hand. Bucket 1320 may be emptied via a dispensing mechanism as opposed to bucket 1320 being removable.

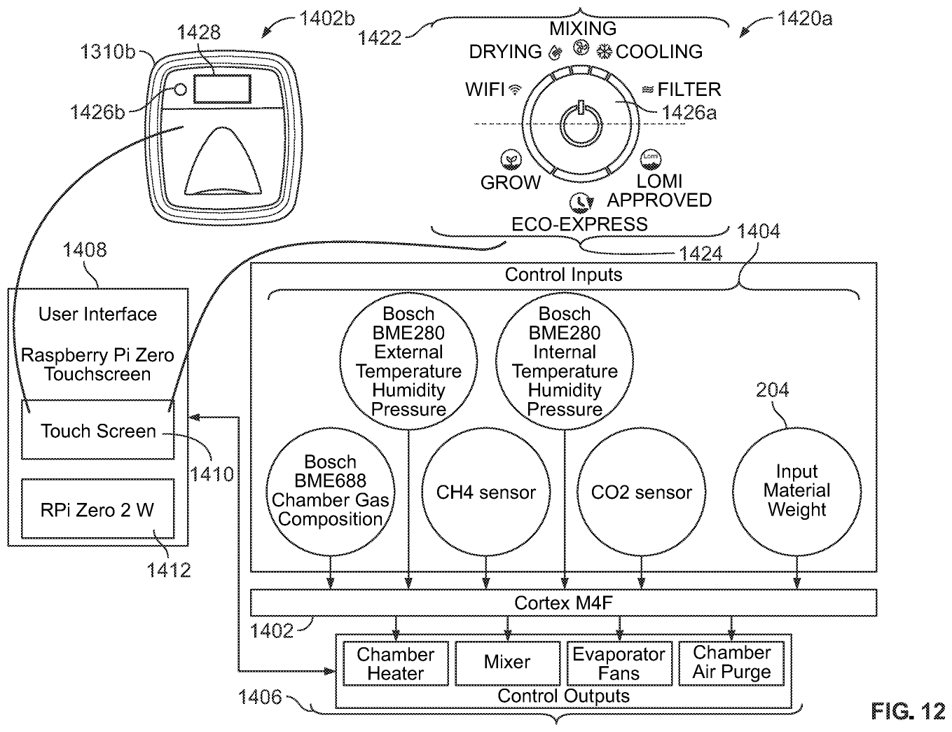

FIG. 12 is an exemplary logical connection for a composting device 102, including user interface elements therefore, according to an embodiment of the present invention.

Elements shown in FIG. 12 maybe located in various parts of composting device 102 and may differ depending on the form factor of composting device 102 such as the differences that can be noted between user interface assembly 1420a which may be part of composting device 102a and user interface assembly 1420b which may be part of composting device 102b

At the heart of the logical connection, or intelligence of, composting device 102 may be one or more controller 1402. Controller 1402 maybe a processor such as a cortex M4F processor. Controller may have various software (such as to operate WRD 102 and perform various processing described herein, including artificial intelligence or ML processing) that controls its operation, stored thereon or in separate memory, as known to those of skill in the art. Controller 1402 may have various control inputs 404 and control outputs 1406 and communication devices such as transceivers. Controller 1402 may also be connected to user interface assembly 1408 examples of which are shown as 1420a and 1420b.

Controller 1402 may be involved in the following:

Receiving inputs (such as a video signal) from, and controlling the operation of, any camera(s) that are part of WRD 102, such as grinder monitoring cameras, noting that the camera feed or video signal may be processed (for functionality herein) and also may be sent to an app on computing device 104 so a user can view WRD 102 performing its functions, “live” or in near real time (both the processor or analysis engine and the app being video signal sinks);

Machine Learning using a gas sensor array (which may be similar to a sensor array) to monitor the system output during processing;

The ability to stop the cycles if issues arise during the process (as may be determined, for example, via sensor data) such as:
(a) A system halt due to toxic gasses being generated from incompatible materials in the chamber/bucket;
(b) If WRD 102 reaches a target composition early in the process the cycle can be stopped to save energy.

As shown in FIG. 12 control inputs 1404 may include a sensor assembly that may include various sensors such as humidity temperature and pressure sensors, methane sensors, carbon dioxide sensors, and chamber gas composition sensors. Sensors may be included or assembled into one or more sensor arrays that may be located so that they may sense physical inputs 1130 in the bucket and outputs such as physical outputs 1132. In addition weight sensors 1204 may be included as control input 1404 that is logically connected to processor 1402. Further exemplary sensors may include one or more of the following:
pH sensor—if composting falls outside a desired range (which may be 5.5-8), consider adding additives or suggesting different waste be added;
Temperature probe—for example to ensure that WRD 102 reaches the temperature that kills most pathogens or pathogens that are sensed (via sensors or a camera);
CO2, CO and O2 sensors—measure CO2 evolution and respiration rate, which may give insights into microbial activity;
CH4 sensor—how much methane is your food waste producing and how would that compare to the landfill;
Ammonia sensor—which may provide insights into the maturity of the dirt/compost (physical output 1132);
Weight sensor—bulk density of the compost;
Volume sensor—bulk density;
NPK (nitrogen, phosphorus, potassium) sensors—which may assist expert gardeners determine how to use the physical output 1132, for example;
Moisture content sensor—where maintaining 40-60% moisture may be ideal, and adjustment steps may be taken if moisture inside WRD 102 falls outside the desired percentage;
Pressure
Nitrous oxide (N2O)
   Nitrous oxide is primarily produced in soil by the activities of microorganisms during the denitrification process where nitrate (NO3) is converted to nitrite (NO2) which is then converted to NO+N2O and then N2 gas.
Ammonia (NH3)
   NH3 can provide insights into compost maturity (measure of phytotoxicity).
   Often used in combination with CO2 evolution which assesses compost stability.
TOC
   This is a useful gauge of the amount of biodegradation happening in Lomi.
Cation exchange capacity
   CEC is a measure of the soil's ability to hold onto essential nutrients. CEC is a useful indicator of soil fertility as it shows the soil's ability to supply important plant nutrients (e.g. calcium, magnesium, potassium, sodium, iron).
Volatile fatty acids
   Volatile fatty acids are indicators of anaerobic fermentation.
Water holding capacity
   This is a measurement of soil quality. If a soil holds water well, it will be good for the plants. But it can't hold too much water, or it could make the roots rot.
   Soils with good WHC can help replenish underground water reservoirs and improve plant resilience in drought conditions.
Condenser to collect moisture and circle it back to lomi
   This will help maintain moisture levels inside of Lomi within a range that is necessary to have microbial activity (if moisture level is too high or too low then this will inhibit microbial activity).
C/N ratio
   This is important to have a good balance of carbon and nitrogen in a ratio that is optimal for composting. C gives microorganisms energy, while N provides nutrition to continue growing and reproducing.
      Too much C=decomposition rate slows.
      Too much N=lose N as ammonia gas (smell) and increased
Sieve to recycle particles that are bigger than a certain size External apps
   AI to determine what you are putting in—tells you if you need more browns and greens.
   Noise app
   Thermal camera

Control outputs 1406 may include various features of WRD 102, such as a chamber heater (to heat up the contents of bucket 1320), a mixer evaporator fans and the chamber air purge. It is to be understood that such control outputs 1404 are only exemplary and further control outputs may be contemplated as part of composting device 102.

Functionally, as would be understood to someone of skill in the art, control inputs may be inputs to processor 1402 while control outputs 1406 maybe features and devices of composting device 102 that may be controlled by controller 1402.

User interface assembly 1408 may comprise touch screen 1410 and RPi Zero 2 W 1412. Shown logically at 1408, user interface assembly 408 may be part of composting device 102b for example by being part of lid assembly 1310b. As shown user interface 1420b may include touch screen 1428 and user button 1426b. Both touch screen 1428 and user button 1426b may display various information about composting device 102b and may also receive various inputs from a user of composting device 102b. User interface 1420a may comprise one or more UI elements 1422 (which may show the current stage of a mode) and 1424 (which may show what mode was selected for composting device 102a).

It is to be understood that FIG. 12 is merely an exemplary depiction of user interface elements, layouts, and accessible functionality. Such elements layouts and functionality may vary according to the functions of composting device 102, the form factor of composting device 102, and other factors.

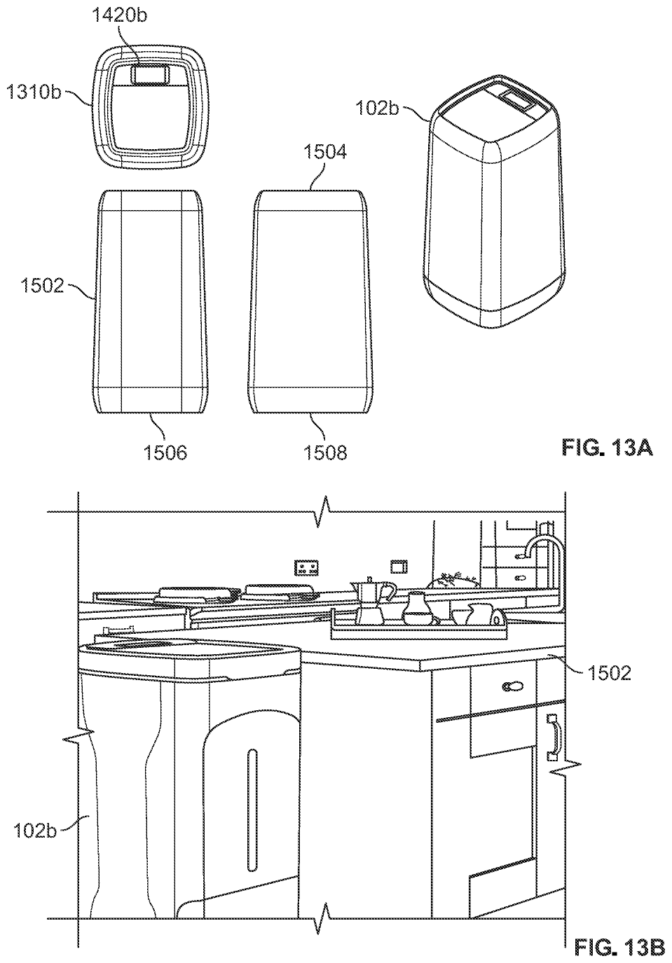

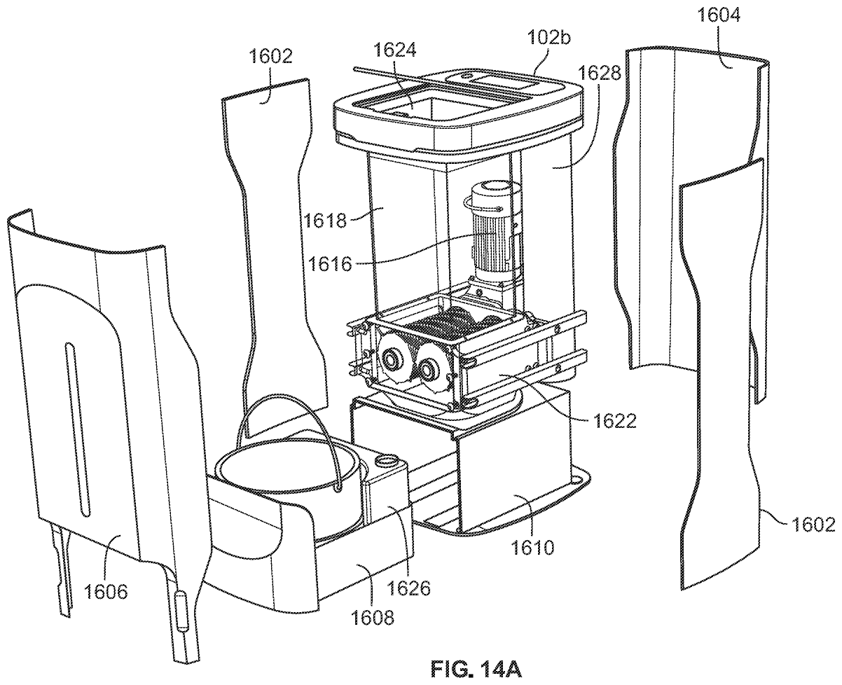

FIGS. 13a-b are illustrations of forms and dimensions for an exemplary composting device according to an embodiment.

FIG. 13a shows composting device 102b comprising user interface 1420b and lid assembly 1310b, as such are further described herein. The dimensions of composting device 102b, as shown at 1502 (which may be approximately 34″), 1504 (which may be approximately 17.5″), 1506 (which may be approximately 18″), and 1508 (which may be approximately 19″) may be selected and designed to improve the functionality of composting device 102b (such as to allow entry points for waste to be sufficiently sized and properly shaped) as well as improve how composting device 102b is integrated in the environment in which composting device 102b is used (for example for 1502 to be selected based on a counter height).

With respect to improved functionality, dimensions of composting device 102b may allow more volume of waste to be added to composting device 102b and may allow larger objects to be added to composting device 102b. Such dimensions, combined with the internal features of composting device 102b, as further described herein and in FIGS. 6a and 6b, may make composting device 102b suitable for larger families, restaurants, and other commercial applications.

With respect to integration in the environment, the dimensions of composting device 102b may be selected such that height 1502, may result in a top surface of lid assembly 1310b being substantially flush with a countertop 1502. This may mean, for example, that a user can simply clean counter 1502 into composting device 102b without having to pick up the waste that is to be put into composting device 102b. As an extension of such a concept for composting device 102b, it may be installed in the middle of a countertop 1502, rendering composting device 102b functional similarly to a garburator when installed in a sink drain. Of course, in such an installation, lid assembly 1310b may be adjusted such that it is easy to open the lid and insert the waste into composting device 102b. This may be with a lid that opens vertically (such as being hingedly attached, allowing access to the bucket when in an open position or hingedly vertical position) or may include a horizontal or sliding lid (not shown, that may be assembled as part of a top surface of the household composting device 102, allowing access to the bucket when in an open position via sliding out of a blocked position).

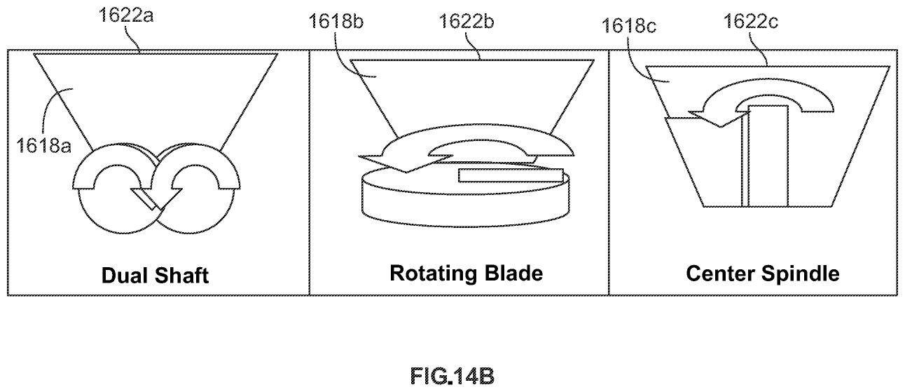

As shown, and further described in FIG. 14a, bucket slide 1608 may allow the bucket to be removed from composting device 102b so that the dirt therein can be placed in its final location. It is contemplated that bucket slide 1608 may be oriented and designed to naturally function in the environment in which composting device 102b is located. For example, in a residential kitchen bucket slide 1608 may be oriented to slide out of composting device 102b and then be accessible in the same location as a user's garbage and recycling bins. In a commercial environment, composting device 102b (and the waste cavity for depositing waste to be turned into dirt) may be accessible to patrons of the commercial establishment, while bucket slide 1608 may be oriented such that employees at the commercial establishment are the ones that are able to access the bucket.

FIGS. 14a-b are elements of exemplary composting devices, and features thereof, according to an embodiment of the present invention.

FIG. 14a shows an exploded view of composting device 102b. A housing assembly may be comprised of a back surface 1604 two side surfaces 1602 and a front surface 1606. Inside of such housing assembly may be motor 1616, grinder assembly 1622, bucket slide 1608 with a bucket and bucket slide receptacle 1610, physical output water reservoir 1626 which may be functionally connected to one or more of bucket and condenser such as 1628, and other elements (not shown). Located below waste hole 1624 may be grinder feeder 1618.

The output (a physical output) may consist of separate condensate and solids. Such system may create a partially sealed chamber to control the environmental parameters during the process and fresh air may only be introduced when necessary to manage the process.

Insulation may be used on various elements of waste device 102 (such as heating chamber, which may comprise elements that may be inside 1610 when in operation).

Depending on various factors, such as the waste and additives put into the composting device, the composting cycles characteristics (length of time, heat, fan operation, grinder operation) the water may have various nutrients, making the water reservoir output suitable for gardens and other applications where nutrients may be beneficial. Of course the sensor arrays described herein may monitor water reservoir outputs and preferred uses thereof.

At a high level, the various components of composting device 102b, as shown in FIG. 14a are arranged such that composting device 102b rests on bucket slide receptacle 1610, into which bucket slide 1608 and bucket go (bucket slide receptacle 1610, and bucket slide 1608, along with other features of composting device 102a/b, as described above, such as heat assembly and a second grinder assembly, may be referred to as the composting region—where the composting cycles describe herein occur). On a top surface of bucket slide receptacle 1610 is an aperture through which waste, that has gone through grinder assembly 1622, may go into the bucket waste as it descends through grinder feeder 1618 to reach grinder assembly 1622 to be ground prior to entering the bucket at which point the composting functionality of composting device 102b (such as cycles, described herein) is applied to the waste that has been ground by going through grinder assembly 1622 the waste reaches grinder feeder 1618 by opening the lid and putting the waste through the opening under the lid various other elements of composting device 102b, such as motor 1616, various filters, and the elements of the logical connection as described herein are located around the central mechanical features as described in shown in FIG. 14a.

As shown in FIG. 14a grinder assembly maybe comprised of one or more shafts 1622 that may have sharp or similarly designed elements to grind waste that descends through grinder feeder 1618 the example shown in FIG. 14a may be substantially similar to the example shown as 1622a in 1618a in FIG. 14b. while the design shown in FIG. 14a may be selected, other designs such as are shown in FIG. 14b may be used depending on their performance with respect to the waste that is contemplated to be provided to composting device 102b. Grinder assembly may provide high efficiency pre-processing of physical inputs 1130, mechanically reducing the size of the pieces of the waste, which reduces required heated processing time (saving energy) and produces a more consistent appearance to the material entering bucket 1320 and eventual physical output 1132.

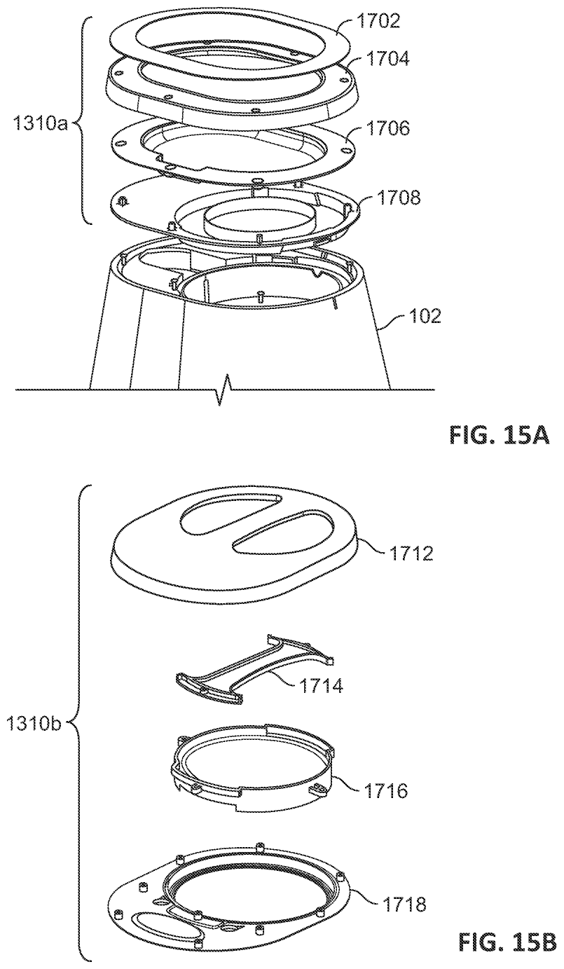

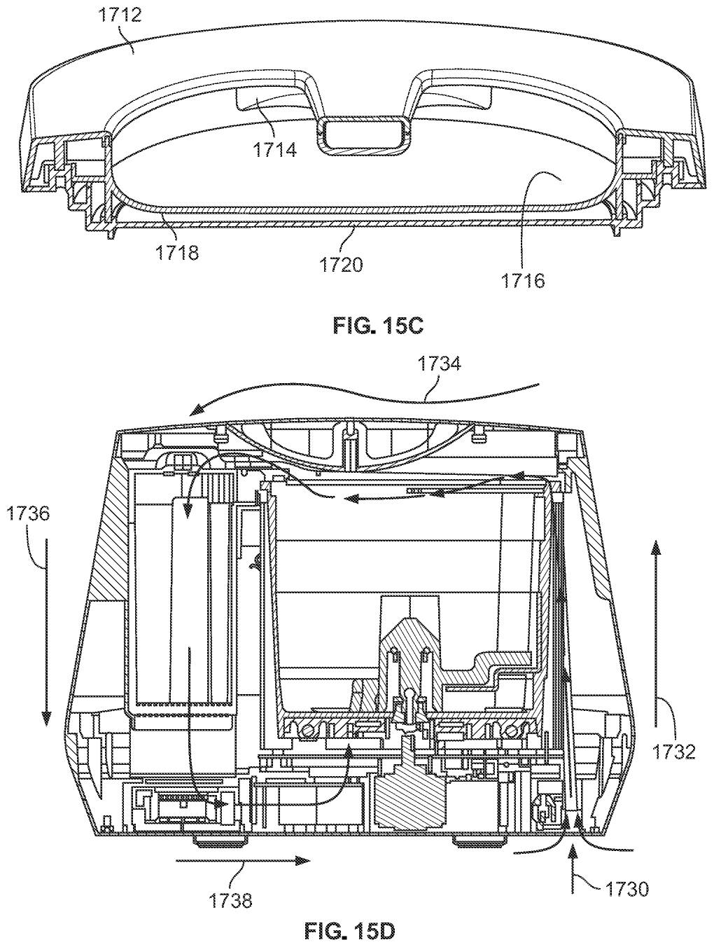

FIGS. 15a-b are exemplary lid assemblies 1310a/1310b for a composting device 102 according to an embodiment of the present invention.

Lid assembly 1310a may be designed to allow a see-through portion of the lid to be part of lid assembly, enabling a user to observe the performance of composting device 102. In addition to a user observing a clear or see-through portion of the lid may enable a camera to be part of lid assembly 1310a and allow the camera to receive enough light because light can pass through such see-through portion of the lid. A camera may be placed so that it can view the contents of the bucket without obstructing a user's view. Further, depending on the selected camera, it may need to be isolated from the moisture or contents of the removable bucket.

As shown in FIG. 15a lid assembly 1310a may comprise various sub elements such as decorative ring 1702, covering 1704, cover 1706, and bottom window part 1708. It may be desirable for lid assembly 1310a to be as mechanically simple as possible while providing the desired and required functionality, such as heat, smell, connection/closure confirmation abilities, another functionality that may be required of lid assembly 1310a.

While a transparent or see-through lid assembly 1310a may be useful for some form factors of composting device 102 (for example, composting device 102a that is located on a countertop) a see-through lid assembly 1310a may not be particularly required, at least from a user's perspective, where composting device 102 is not as accessible or visible to a user.

FIGS. 15b and 15c show an alternative lid assembly 1310b, comprising various layers 1712, 1714, 1716, 1718. Lid assembly 1310b includes a clear layer 1718. In addition, the other layers 1712, 1714 and 1716, when added to layer 1718, may form one or more lid air outlets, such as air outlet 1720, seen in the cutout view in FIG. 15c. Clear lid bottom layer 1718 (the layer disposed closest too and/or forming a seal with the bucket) may have an angled lower surface (i.e. the surface that prevents air from escaping the bucket), tilted to cause airflow in the direction of the airflow show in FIG. 15d. Layer Lid air outlet 1720, and the angled bottom edge of layer 1718 (which may form air outlet 1720), may allow increased airflow out of the bucket of composting device 102, which reduces the humidity inside composting device 102 which would otherwise make the interior of composting device 102 too foggy to view the waste materials as they are turned into dirt. This may occur by the increased airflow, in the proper direction, pulling humidity off the bottom surface of the lid 1718/1708.

As shown in FIG. 15d, air may flow through composting device 102 by coming in an inlet near airflow direction arrow 1730, ascend in the direction of 1732, enter the bucket and be directed towards the bucket airflow outlet by layer lower surface as described and shown by 1734, go through one or more filters in the direction of 1736 and then exit via an exhaust as the air flows in the direction of 1738.

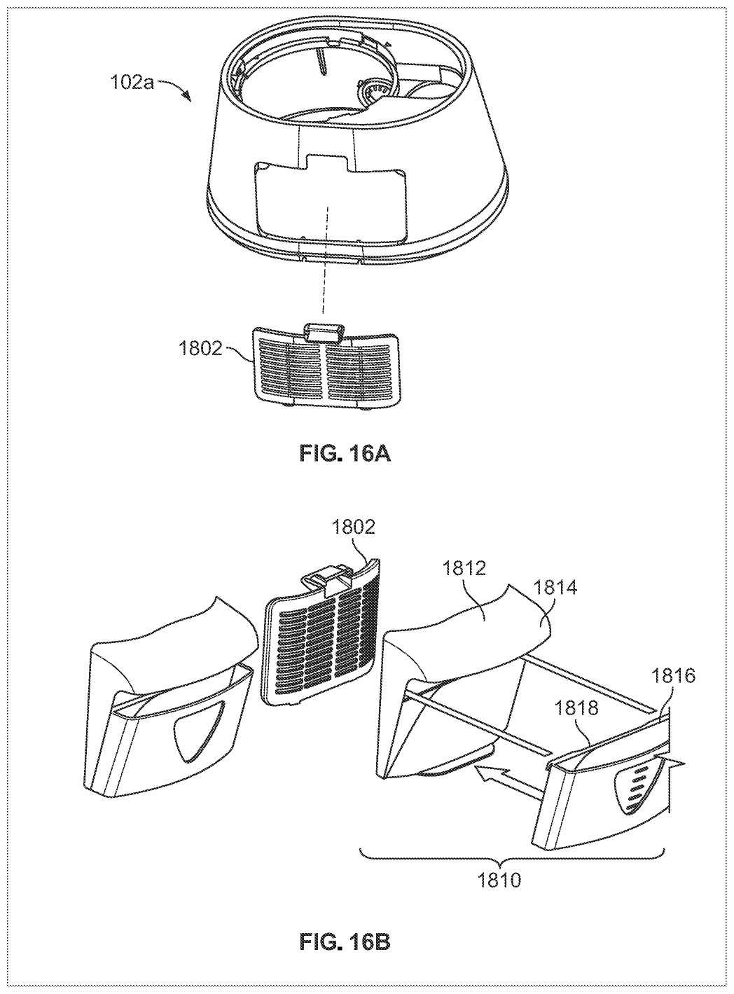

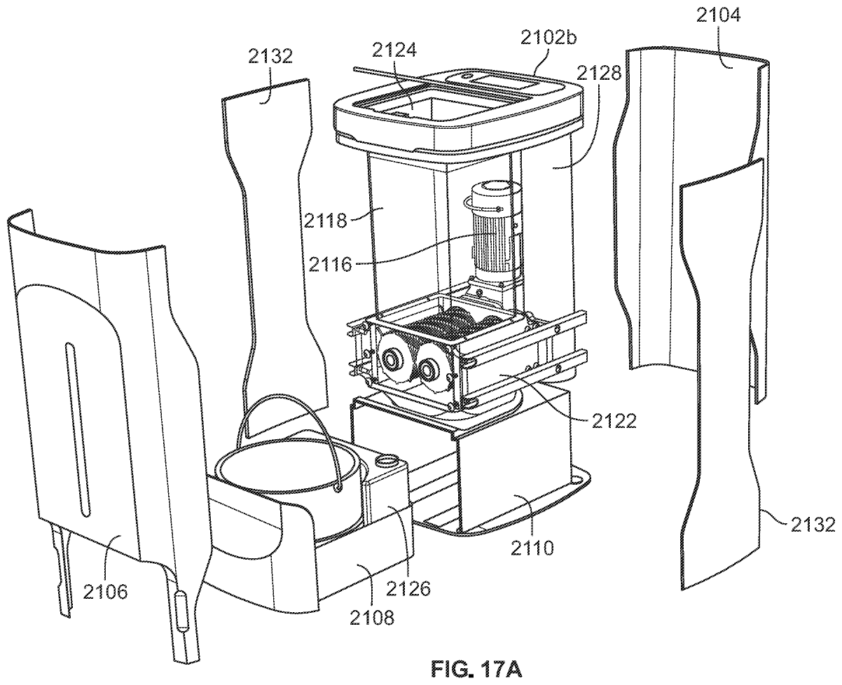

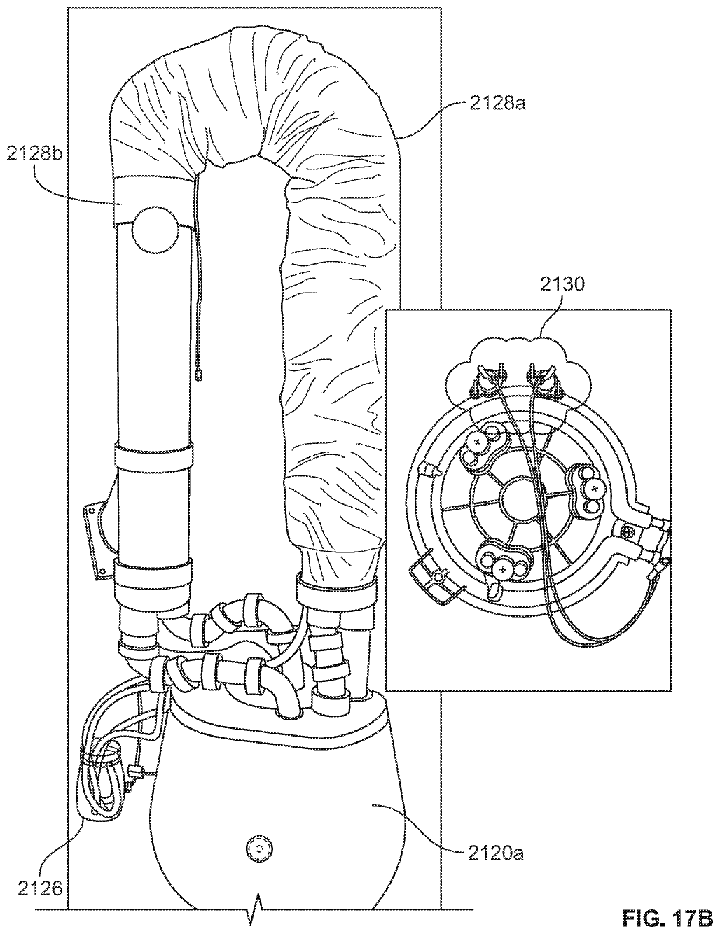

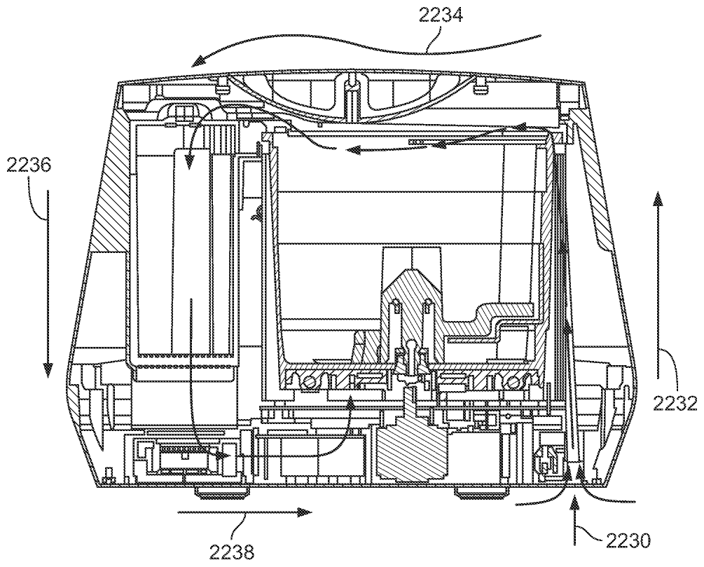

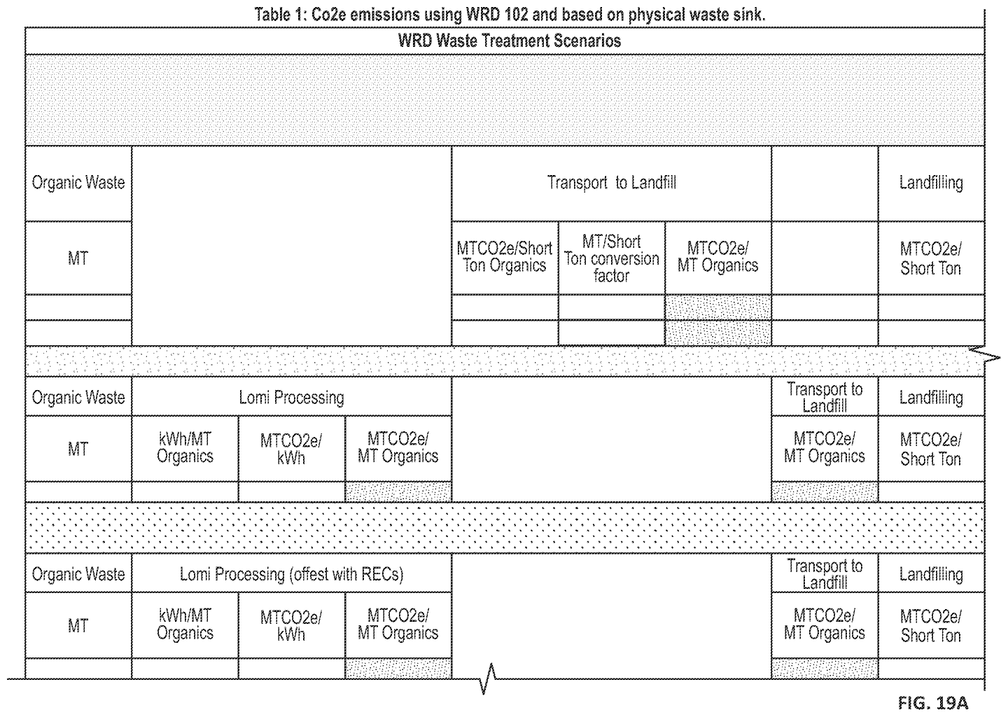

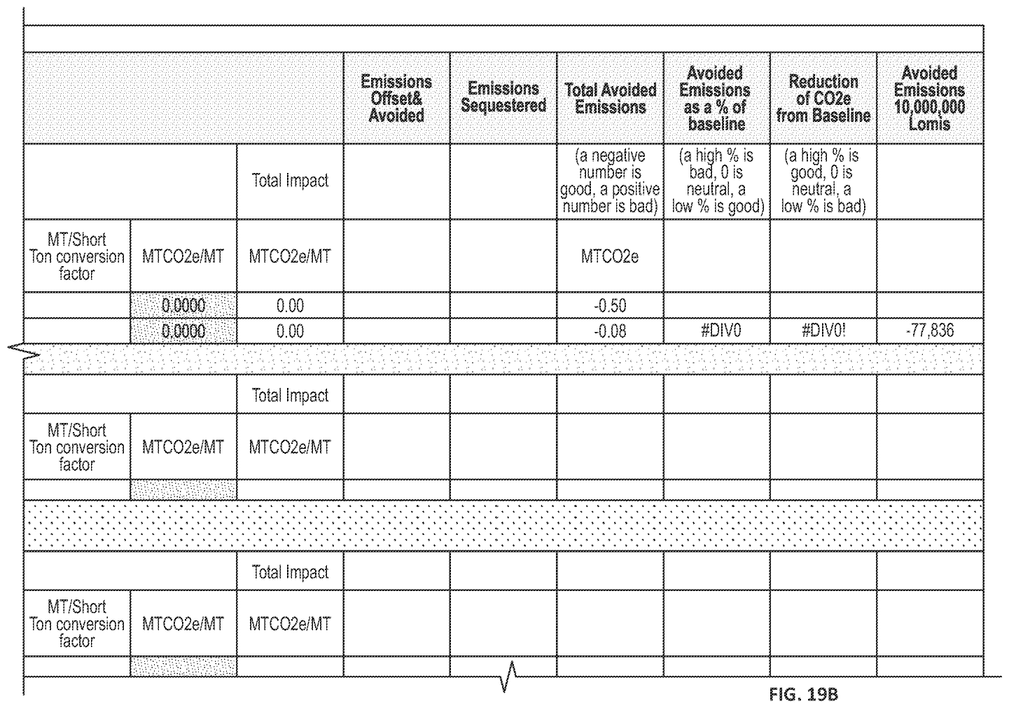

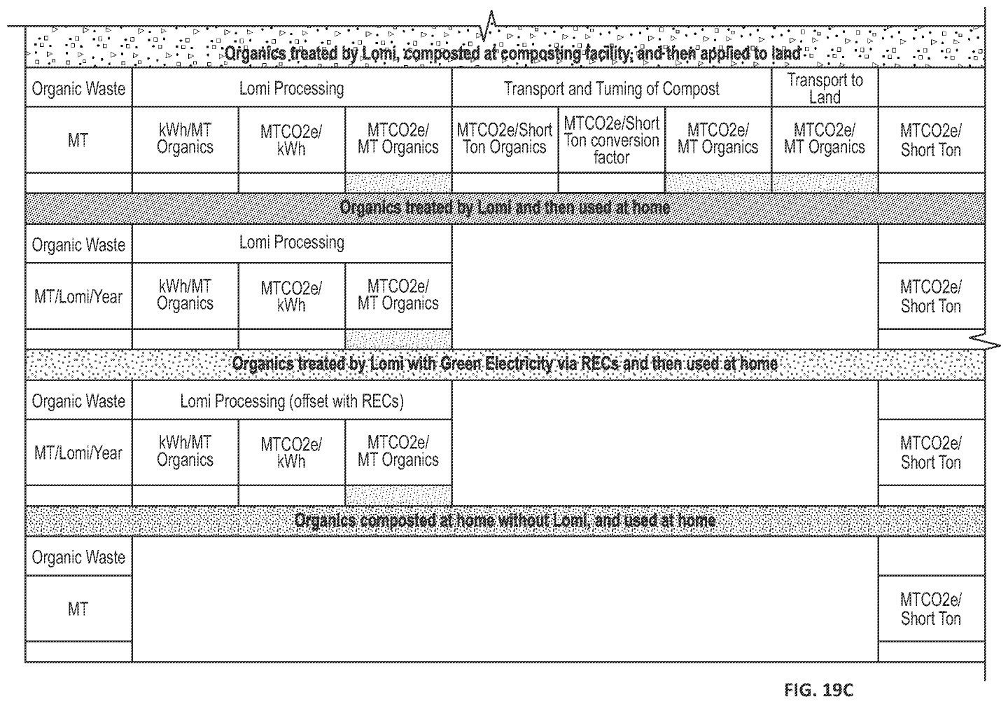

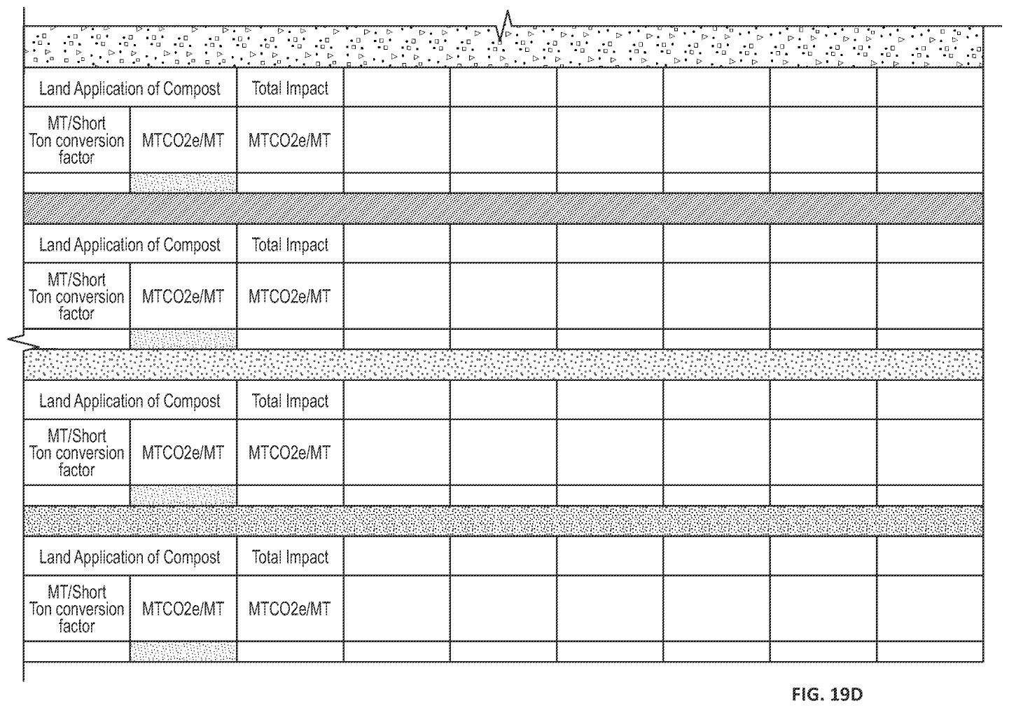

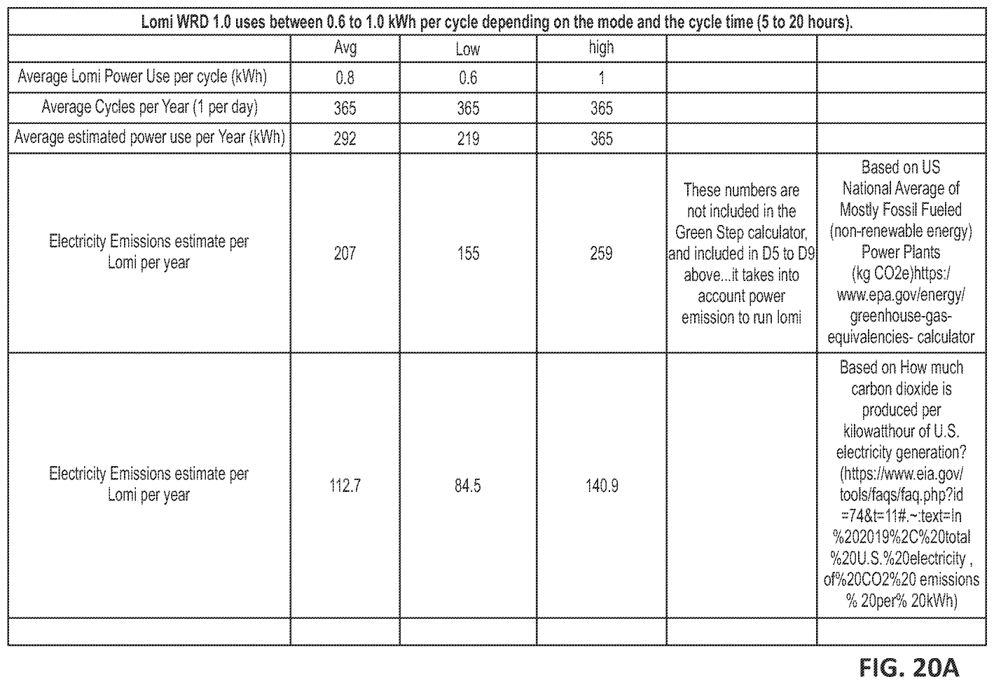

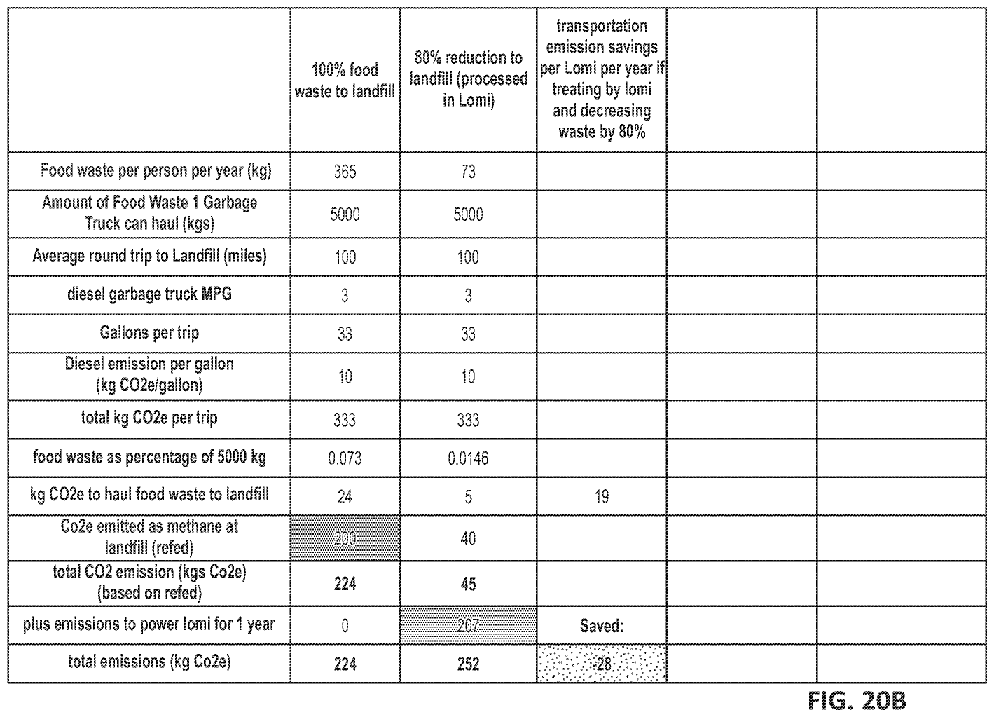

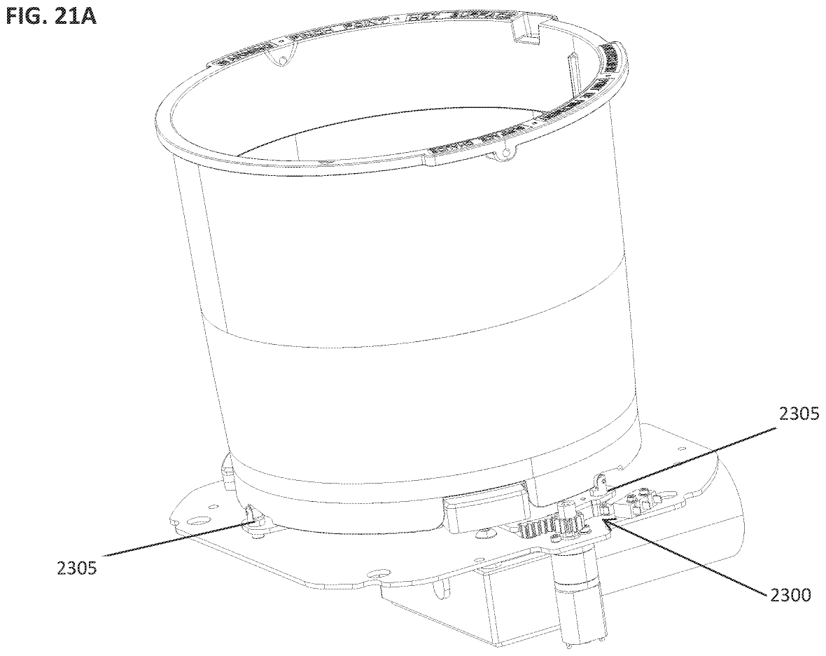

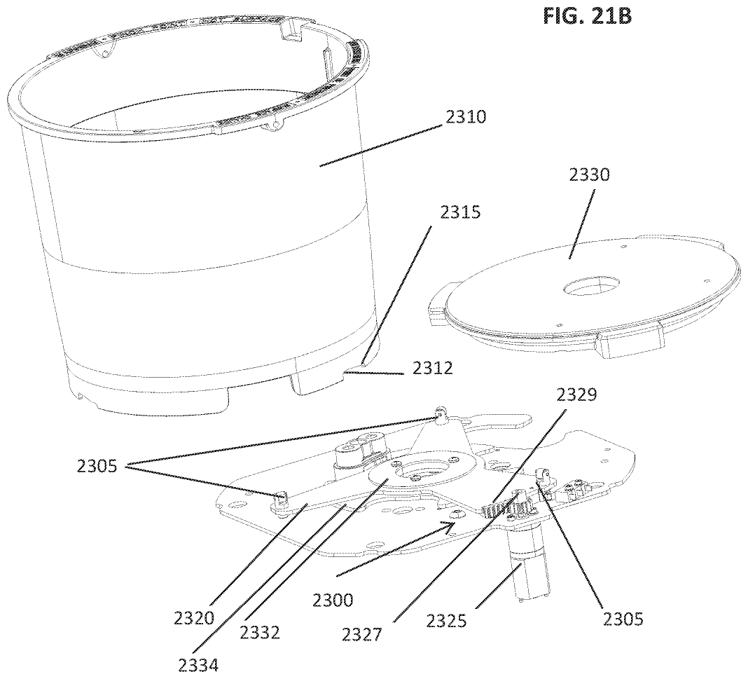

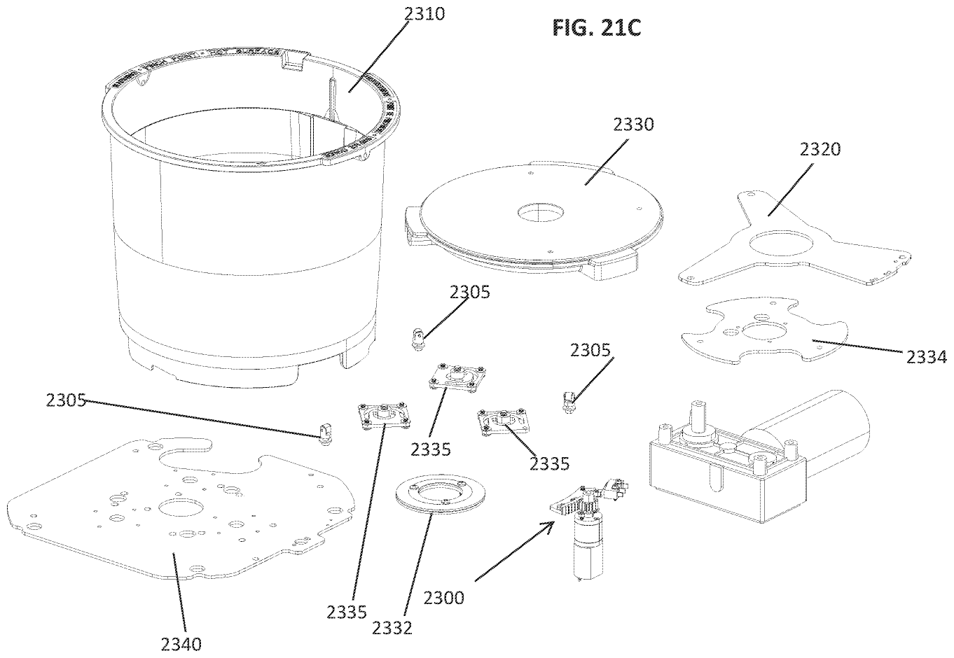

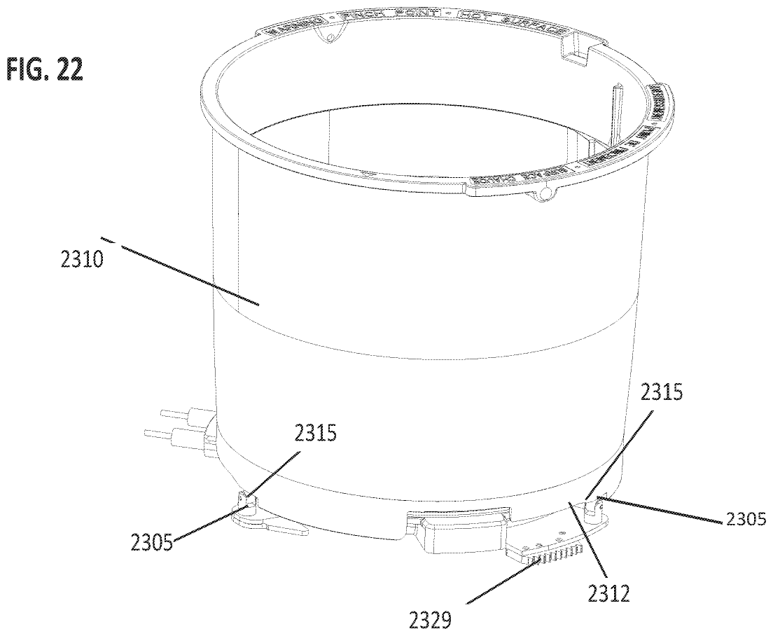

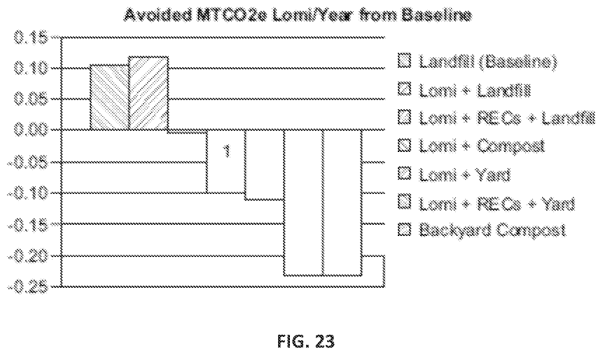

FIGS. 16a-b are an exemplary steam diversion assembly for a composting device according to an embodiment of the present invention.

In some embodiments of composting device 102, the heat and steam generated in operating composting device 102 may be enough that based on the location of composting device 102 a more sophisticated approach to dealing with steam expelled from composting device 102 may be desirable. For example, if composting device 102a is located underneath cupboards or on a porous surface then the collection of steam and resulting moisture may not be desirable to allow to collect on such surfaces. This type of consideration may also apply to composting device 102b, again depending on where it is located and how it is integrated with its environment.

FIG. 16A shows composting device 102a with filter 1802. Filter 1802 may be removable from composting device 102a regardless of whether a moisture capture assembly is used. In FIG. 16b steam diversion assembly (or moisture capture assembly) 1810 is shown and comprises diverter 1812 which further comprises diversion lip 1814, and water collector 1816 which further comprises water receptacle 1818. Diversion lip 1814 is designed such that when heat or moisture comes out of the heat exhaust (outlet) that is covered by the steam diversion assembly 1810 it collects on the bottom surface of steam diverter 1812 and diversion lip 1814, with diversion lip 1814 being directed such that drips that fall from diversion lip 1814 end up in water receptacle 1818. As a result, water receptacle 1818 may contain a physical liquid output after operation of a composting cycle (for example after heating and grinding of the waste material deposited in composting device 102). Water receptacle and water collector 1816 can be removed from composting device 102a to be emptied and may be removed without removing the rest of moisture capture assembly 1810.

FIGS. 17a-b are elements of exemplary condensers for composting devices, and features thereof, according to an embodiment of the present invention comprising a composting device or WRD 102 and a condenser assembly.

FIG. 17a shows an exploded view of composting device 2102b (which may be similar to waste device 2102a, resized to encapsulate condenser assembly inside the housing, as opposed to being external thereto as in FIG. 17b). A housing assembly may be comprised of a back surface 2104 two side surfaces 2132 and a front surface 106. Inside of such housing assembly may be motor 2116, grinder assembly 2122, bucket slide 2108 with a bucket and bucket slide receptacle 2110, physical output water reservoir 2126 which may be functionally connected to one or more of bucket and air management system and condenser such as 2128, and other elements (not shown). Located below waste hole 2124 may be grinder feeder 2118.

Condenser and air management system, or condenser assembly, may comprise various elements such as water reservoir 2126 and inlet/outlet or duct 2128a/b, among others, may reduce the moisture content of the output faster than typical air cycling, improve drying process efficiency, collects the condensate to reduce the amount of exhausted moisture. The output (a physical output) may consist of separate condensate and solids. Such system may create a partially sealed chamber to control the environmental parameters during the process and fresh air may only be introduced when necessary to manage the process.

Insulation may be used on various elements of waste device 2102 (such as heating chamber, which may comprise elements that may be inside 2110 when in operation), and aspects of the condenser and air management system.

In operation, air and moisture (via liquid or gases) may be pulled out of waste device 2102a/b at various stages of operation, for example to improve the quality and efficiency of a composting cycle and result in better physical outputs (such as waste outputs). In so doing, condenser and air management systems, and components that assist with such, may obtain water that ends up in water reservoir 2126. Depending on various factors, such as the waste and additives put into the composting device, the composting cycles characteristics (length of time, heat, fan operation, grinder operation) the water may have various nutrients, making the water reservoir output suitable for gardens and other applications where nutrients may be beneficial. Of course the sensor arrays described herein may be used with the condenser and air management system, including water reservoir 2126, to monitor water reservoir outputs and preferred uses thereof.

At a high level, the various components of composting device 2102b, as shown in FIG. 17a are arranged such that composting device 2102b rests on bucket slide receptacle 2110, into which bucket slide 2108 and bucket go (bucket slide receptacle 2110, and bucket slide 2108, along with other features of composting device 2102a/b, as described above, such as heat assembly and a second grinder assembly, may be referred to as the composting region—where the composting cycles describe herein occur). On a top surface of bucket slide receptacle 2110 is an aperture through which waste, that has gone through grinder assembly 2122, may go into the bucket waste as it descends through grinder feeder 2118 to reach grinder assembly 2122 to be ground prior to entering the bucket at which point the composting functionality of composting device 2102b (such as cycles, described herein) is applied to the waste that has been ground by going through grinder assembly 2122 the waste reaches grinder feeder 2118 by opening the lid and putting the waste through the opening under the lid various other elements of composting device 2102b, such as motor 2116, various filters, and the elements of the logical connection as described herein are located around the central mechanical features as described in shown in FIG. 17a.

As shown in FIG. 17a grinder assembly maybe comprised of one or more shafts 2122 that may have sharp or similarly designed elements to grind waste that descends through grinder feeder 2118.

Shown in FIG. 18 is an example of a condenser for waste disposal device 2102, which includes outlet duct 22128b and inlet duct 2128a. In practice, hot air (an outlet air flow) may leave via 2128b and be exposed to cooler air (such as room temperature air), with moisture or condensate forming as a result of the outlet air flow inside outlet duct 2128b being cooled by the cooler air flow. The condensate may fall to the bottom of outlet duct 2128b, as the outlet air flow is rising vertically, and be collected in the water reservoir 2126. Outlet duct 2128b and inlet duct 2128a may comprise both an inner and outer tube or pipe, such that outlet airflow from the composting region be inside an inner tube and room temperature airflow may be introduced inside the outer tube but outside the inner tube. Hot air (now likely cooler, though likely still warmer than room temperature) goes through the ducts and may be directed back into the bucket or composting region as an inlet airflow via inlet duct 2128a, to keep the temperature higher in a more efficient way (including insulating parts of duct 2128, for example as shown covering 2128a). Control thermocouple 2130 may be used to ensure the effective use of the heat.

As shown in FIG. 18, air may flow through composting device 2102 by coming in an inlet near airflow direction arrow 230, ascend in the direction of 2232, enter the bucket and be directed towards the bucket airflow outlet (such as 2128b) as shown by 2234, go through one or more filters in the direction of 2236 and then exit via an exhaust as the air flows in the direction of 2238. Of course, the inlet and outlet ducts, as shown and described herein, may be part of the overall airflow as well, which may result in a closed air flow once air has entered WRD 2102.

Referring now to FIGS. 21-22, there is shown in another embodiment the weight sensor assembly being be placed under the bucket. In this embodiment the weight sensor assembly includes a lift mechanism 2300. Lift Mechanism works by utilizing three lifting rollers 2305 under the bucket 2310. The rollers 2305 are attached to a rotating plate 2320, which can be actuated by a lifting motor 2325 that rotates back and forth via a pinion 2327 meshed to a rack 2329. When the rotating plate 2320 is rotated Counter-Clockwise, the rollers 2305 are moved under the bucket 2310 and engage with bucket ramps 2315 on the bottom edge 2312 of the bucket 2310. The bucket ramps 2315 in turn cause the entire bucket 2310 and its contents to be lifted approximately 1.8 mm off of the heater plate 2330. When the bucket 2310 is lifted, all the weight of the bucket and its contents get transferred through a bearing plate 2332 and onto a load plate 2334 connected to three load cells 2335 (or weight sensors) under a main assembly plate 2340. This allows the unit to get an accurate weight reading of the bucket 2310 and its contents. When the bucket 2310 is not in the lift position, the bucket and its contents are sitting directly on the heater plate 2330 leaving the load cells 2335 unloaded/disengaged. During this unloaded/disengaged state, the assembly is able to accurately Tare/Zero the weight readings.

The computer systems and computing devices described herein may comprise various elements, such as at least one processor that may control the overall operation of the computing device. The computing devices may be interconnected with a non-transitory computer readable storage medium such as a memory which may be any desired combination of volatile (i.e. RAM) and non-volatile (i.e. ROM), including Electrically Erasable Programmable Read Only Memory (“EEPROM”), flash memory, magnetic computer storage device, or optical disc memory. Computing devices may also include one or more input devices interconnected with a processor. Such input devices may be configured to receive input and provide data representative of such input to a processor. Input devices can include, for example, a keypad, touchscreen, and a pointing device. In some examples, such as with devices 102, a computing device can include additional input devices in the form of one or more additional buttons, light sensors, microphones and the like.

Computing devices may further include one or more output devices. The output devices of computing devices may include a display which may include display circuitry controllable by a processor for generating interfaces which include representations of data and/or applications maintained in memory. The display circuitry can thus include any suitable combination of display buffers, transistors, LCD cells, plasma cells, phosphors, LEDs and the like. Additional output devices are also contemplated.

Computing devices may also include communications interfaces or transceivers interconnected with a processor. Communications interfaces allow computing devices to perform voice and/or data communications via a link, which can be wired and/or wireless, and, where appropriate, with or via a network such as 108. The communication interface receives messages from and sends messages through these links. Computing devices may have applications, apps, data, and the like, which may be stored in memory and accessed by a processor and various input and output devices.

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations.

It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Aspects described in one embodiment may be combined in any manner with aspects described in other embodiments. Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In addition to the claims outlined herein, there are additional methods, systems, and devices outlined herein.

In one additional embodiment there is a method for the creation of a waste reduction token, based on waste reduction by a waste reduction device, the method comprising: receiving, from the waste reduction device manufacturer, a waste reduction device dataset; validating, by a validator, the waste reduction device dataset; and calculating a number of waste reduction tokens, based on the validated waste reduction device dataset. In addition thereto the waste reduction device dataset may comprise a number of waste reduction devices, an operation period for each of the waste reduction devices, and a waste reduction per unit of time assumption. In addition thereto, the method may further comprise writing, to a waste reduction token blockchain by a smart contract, a waste reduction token transaction dataset. In addition thereto, the waste reduction token transaction dataset may further comprise one or more waste reduction token transaction datasets, each of the waste reduction token transaction datasets comprising the number of waste reduction tokens and a waste reduction device owner wallet identifier.

In another additional embodiment, there is method for the calculation of an environmental benefit of the operation of a waste reduction device, the method comprising: receiving, from the waste reduction device, a waste reduction data; validating, by a validator, the waste reduction data; and calculating the environmental benefit, based on the validated waste reduction data. In addition thereto, the waste reduction data comprise an initial waste weight of the contents, which comprises food, added to a receptacle of the waste reduction device and a completed waste weight of the contents, which comprises dirt, of the receptacle of the waste reduction device after operation of the waste reduction device. In addition thereto, the waste reduction data further comprise one or more characteristics of the input waste and one or more characteristics of the output waste, wherein the characteristics comprise one or more of their moisture and their chemical composition. In addition thereto, the method further comprise obtaining, from one or more of the waste reduction device, an app of a user of the waste reduction device, or using a location of the waste reduction device, an electricity source used to power the waste reduction device and a physical output sink for the contents of the receptacle after operation of the waste reduction device.

What is claimed is:

1. A method for the creation of a waste reduction token, based on waste reduction by a waste reduction device, the method comprising:
receiving, from the waste reduction device, a waste reduction data;
validating, by a validator, the waste reduction data; and
calculating a number of waste reduction tokens, based on the validated waste reduction data.

2. The waste reduction method of claim 1, wherein the waste reduction data comprise an initial waste weight of the contents, which comprise food, added to a receptacle of the waste reduction device and a completed waste weight of the contents, which comprise dirt, of the receptacle of the waste reduction device after operation of the waste reduction device.

3. The waste reduction method of claim 2, further comprise writing, to a waste reduction token blockchain by a smart contract, a waste reduction token transaction dataset.

4. The waste reduction method of claim 3, wherein the waste reduction token transaction dataset comprise the number of waste reduction tokens and a waste reduction device owner wallet identifier.

5. The waste reduction method of claim 4, wherein the waste reduction data further comprise the waste reduction device owner wallet identifier.

6. The waste reduction method of claim 5, further comprising obtaining, from a user computing device associated with the waste reduction device, the waste reduction device owner wallet identifier.

7. The waste reduction method of claim 1, wherein the validating step further comprise:
authenticating the waste reduction device; and
applying one or more waste reduction data filters to the waste reduction data.

8. The waste reduction method of claim 1, wherein the receiving step occurs shortly after the waste reduction device completes its operation.

9. A household composting device having a housing and a composting region for receiving compostable waste material, the composting device further comprising:
a removable bucket positioned within the housing for receiving the compostable waste material;
a weight sensor assembly, communicatively connected to a processor, and configured to determine a weight of the composting device or the removable bucket;
the processor, communicatively connected to the weight sensor assembly, configured to:
obtain a weight of the composting device or the removable bucket from the weight sensor assembly.

10. The household composting device of claim 9, wherein the weight sensor assembly may comprise one or more weight sensors, that operate together to determine the weight of the composting device.

11. The household composting device of claim 10, further configured to: determine an initial weight of the composting device or the removable bucket, taken with compostable waste material in the bucket and before a composting cycle has been performed; and get a final weight of the composting device or the removable bucket, taken after the composting cycle has been performed; and determine a weight reduction amount, based on the initial weight and the final weight.

12. The household composting device of claim 11, wherein the processor is further configured to communicate a household composting device dataset.

13. The household composting device of claim 12, wherein the weight sensor assembly is disposed on one of a bottom surface of the composting device or a bottom of the removable bucket.

14. The household composting device of claim 12, further comprising a heating mechanism that comprises a heating element located inside the housing and configured to heat the bucket when activated; and a grinding assembly configured to grind compostable waste material in the removable bucket.

15. The household composting device of claim 12, further comprising
a sensor assembly in communication with the processor, comprising a set of sensors, communicatively connected to a processor, and configured to determine one or more characteristics of the physical inputs and physical outputs

16. The household composting device of claim 15, wherein the physical outputs comprise a solid waste output and a liquid waste output, which may have various physical and nutrient compositions.

17. The household composting device of claim 16, wherein the set of sensors comprise at least one of a pH sensor, a CO2 sensor, a CO sensor, an O2 sensor, a CH4 sensor, an NPK sensor, a nitrous oxide sensor, an ammonia sensor, a TOC sensor for biodegradation sensing, a volatile fatty acid sensor, and one or more sensors to calculate the carbon/nitrogen ratio.

18. The household composting device of claim 9 further comprising:
a top surface comprising a lid, wherein the lid has a clear portion, allowing a user of the household composting device to view into the removable bucket when the lid is in a closed position; and
a camera, mounted in the lid and configured to capture an interior of the removable bucket when the lid is closed.

19. The household compositing device of claim 18, further comprising a processor, communicatively connected to the camera, and wherein the processor is configured to obtain a video signal from the camera and transmit the video signal to a video signal sink.

20. The household compositing device of claim 9 further comprising:
a moisture capture assembly, attached to an outlet from the composting region, configured to direct and capture the moisture leaving the composting region with the outlet;
a diverter, which further comprises a diversion lip, configured such that when moisture comes out of the outlet the moisture collects on a bottom surface of the diversion lip, and wherein the diversion lip is directed such that moisture drips that fall from the diversion lip are directed into a water receptacle, and a water receptacle that collects the moisture drips which comprise a physical liquid output from the household composting device.
